(19) United States
(12) Patent Application Publication
(10) Pub. No.: US 2015/0013326 A1
(43) Pub. Date: Jan. 15, 2015

(54) POWER GENERATING APPARATUS

(71) Applicant: NRG SMARTS LIMITED, London (GB)

(72) Inventor: Gordon Roy Tait, London (GB)

(21) Appl. No.: 14/374,533

(22) PCT Filed: Jan. 17, 2013
(86) PCT No.: PCT/GB2013/050098

§ 371 Date: Jul. 25, 2014

(30) Foreign Application Priority Data
Jan. 25, 2012 (GB) 1201238.1

(51) Int. Cl. F03B 17/04; F03B 17/02

(52) U.S. Cl. CPC F03B 17/04; F03B 17/02
USPC 60/496

(57) ABSTRACT

Power generating apparatus comprising a deep liquid container having a deep liquid therein, an endless rotatable loop element at least in part in the deep liquid container, and configured to be rotated by a driver about a horizontal or substantially horizontal axis of rotation, and energy harvester associated with the rotatable loop element. The rotatable loop element comprises at least one vessel including at least one variable-shape fluid-tight gas chamber and movable separator defining at least in part the gas chamber. The in use movable separator being at least partially movable in response to a change in hydropressure and the in use energy harvester harvesting energy as the movable separation means moves. The movable separator contracts or expands its captured gas volume in direct response to the changing external liquid pressures upon it as the vessel or descends.

The present invention relates to a power generating apparatus and additionally to a power generator that requires use of the power generating apparatus in conjunction with a body of liquid and compressible gas.

Several species of deep-diving sea mammals and sea birds have developed extremely efficient and minimal energy outlay methods for frequently moving their substantial body volumes from a sea's surface into very deep water, before returning to the water's surface again.

A sperm whale may dive to depths in excess of 3 km and may remain submerged for more than 90 minutes. It undertakes this considerable task in the uncertainty of catching prey at extreme water depths, where its evolved echolocation senses may provide advantages at dark depths that it does not have at the surface.

A blue whale has evolved a rib cage without a sternum and has evolved an external ridge-and-valley structure comprising skin, blubber and muscle that effectively covers and supports that sternum-less area. It is known that this ridge-and-valley structure is used to great advantage when the mouth area is greatly expanded to sweep up large volumes of sea-food. It is also likely that this same ridge and valley structure may greatly compress, in harmonic conjunction with its sternum-less rib cage, to provide physical lung compression at great sea depths. Such evolved physiology may mean that whales have been undertaking such daunting tasks for millions of years. The minimal energy outlay methods for a whale to reach such impressive depths, where external water pressure on a whale's body may be in excess of 4,000 lbs per square inch (approximately 27.6 Megapascal) at maximum depth, is not yet fully understood.

Such deep-diving travel efficiency is reasonably assumed to be reliant on the whale's tailstock and tail fluke being flexed to provide thrust for laminar flow over the whale's hydrodynamic form, in harmonic conjunction with the whale's various biomass densities and the whale's ability to muscularly control the volume of its lungs to achieve best displacement ratios for diving and re-surfacing efficiencies for all depths.

If a group or pod of similar sized cetaceans could be trained to sequentially dive and re-surface, in nose-to-tail formation, to form an endless diving and re-surfacing loop, it is reasonable to assume that the energy input for N similar sized cetaceans in the diving loop could be significantly less than the energy input requirements for an individual cetacean diving and re-surfacing N times.

Such a group based approach for reducing the total energy input of a group of N similar creatures working in unison, by improving laminar flow, is well known in the ‘V’ formations of migrating flocks of large birds, such as geese.

Also, for a deep diving whale, internal muscular energy input is required to muscularly reduce the volume of air in the lungs to increase displacement conditions for diving, and internal muscular energy input is required to muscularly increase the volume of air in the lungs to decrease displacement conditions for re-surfacing.

Furthermore, for a deep diving whale, the internal volume required for life support in conjunction with the whale's various biomass densities relative the density of seawater may mean that only small percentage changes to the lung volumes are assigned to actual lung displacement for extremely efficient diving and re-surfacing needs.

Submarines are perhaps the closest man-made inventions that compare with the size and marine abilities of such deep diving whales. It is known that a submarine dives by actively replacing air in its ballast tanks with seawater, causing its weight to increase. The air is actively removed from the ballast tanks by energy consuming pumps for storage of the removed air in high pressure-low volume storage tanks. A submarine may displace 6,900 tons of seawater on the surface and may displace 7,200 tons when submerged. Thus, ballast tanks capable of receiving 300 tons of seawater, (an approximate one half percentage overall weight increase), causes the submarine to submerge. Energy consuming pumps capable of actively forcing 300 tons of water from the same ballast tanks and replacing it with air released from the same high pressure-low volume storage tanks back into the ballast tanks, causes the submarine to re-surface.

If a fleet of similar sized submarinal vessels could be arranged to sequentially dive, in nose-to-tail formation, to provide increased laminar flow by providing an endless diving loop of such vessels, it is also reasonable to assume that the energy input for N similar sized submarinal vessels in the diving loop could be significantly less than the energy input requirements for an individual submarinal vessel diving and re-surfacing N times.

For a submarine, internal energy input is required to reduce the air volume in a ballast tank thereby providing dive displacement needs, and internal energy input is again required to increase the air volume in a ballast tank to provide re-surfacing conditions.

For a submarine, the substantial internal volume required for human life support systems and military function needs may be greater than 99% for submarines, with only 1% of the volume assigned to displacement for actual diving and re-surfacing needs.

It is a key object of the invention to mechanically replicate the lung control, ridge and valley skin compressing abilities and diving skills of the aforementioned cetaceans for the purpose of capturing and making use of the known pressures that exist in a fluid reservoir, for conversion into, for example, mechanical or electrical energy. It is another object of the invention to make use of liquid pressure differentials that are known to exist at all depths of a fluid reservoir, by providing a looped array of similar sized vessels, for looped rotation within a deep liquid.

According to a first aspect of the invention, there is provided power generating apparatus comprising a deep liquid container having a deep liquid therein, an endless rotatable loop element at least in part in the deep liquid container, drive means for rotating the rotatable loop element about a horizontal or substantially horizontal axis of rotation, and energy harvesting means associated with the rotatable loop element, the rotatable loop element comprising at least one vessel including at least one variable-shape fluid-tight gas chamber and movable separation means defining at least in part the gas chamber, the in use movable separation means being at least partially movable in response to a change in hydropressure during rotation of the rotatable loop element and the in use energy harvesting means harvesting energy as the movable separation means moves.

The term ‘power generator’ used herein and throughout is intended to mean energy conversion from one form of energy to another in order to provide a power output. Power is outputtable by the apparatus by the input of suitable and sufficient energy.

The deep liquid container may be an open body of water. In this case, the open body of water may be at least one of a reservoir, river, lagoon, sea, and ocean.

Beneficially, the or a further deep liquid container may comprise an endless housing forming an enclosed liquid chamber, and the movable separation means of the said at least one vessel of the rotatable loop element includes an endless movable separating member within the housing, the movable separating member enclosing the gas chamber in a radial direction. Furthermore, the liquid chamber may include a plurality of arcuate and spaced apart baffles disposed therewithin. Consequently, the movable separation means may preferably form at least part of a collapsible/expandable lung member. As such, the collapsible/expandable lung member may be connected to the endless housing.

Advantageously, the endless housing may be one of: toroidal, or substantially toroidal, and endless elongate band form.

Preferably, the movable separation means is one of: toroidal or substantially toroidal, and endless elongate band form.

The movable separation means may comprise a plurality of fluid-tight interconnected links to enable contraction of the gas chamber. In this case, at least one of the links may be one-piece. Furthermore, the one-piece link may have a triangular or substantially triangular lateral cross-section.

Beneficially, at least one further said link may interconnect the one-piece link by having two or more pivotably interconnected link portions.

Furthermore, the energy harvesting means may include at least one piezo-electric device disposed within one or more of the said links.

In one configuration, the rotatable loop element may be circumferentially subdivided into a plurality of compartments to form a plurality of said vessels, each compartment being separated from an adjacent compartment by a flexible and resilient pressure differential gaiter. In this case, the energy harvesting means may include at least one piezo-electric device disposed within one or more of the said pressure differential gaiters.

In a further configuration, the gaiters may be removed to provide a single gas chamber compartment that circumscribes the entirety of the internal parts of the rotatable loop element.

The said at least one vessel is preferably rotatable within the deep liquid container. However, the said at least one vessel may be rotatable together with the deep liquid container.

In a further example, the rotatable loop element may preferably comprise a plurality of interconnected submersible said vessels, each said vessel includes a said fluid-tight gas chamber and a gas tight liquid chamber. In this case, the movable separation means may comprise a fluid tight piston in a cylinder defining at least in part the gas chamber and the liquid chamber. Furthermore, the movable separation means preferably include a piston pressure plate which is connected to a bellows, an opposing end of the bellows being connected to an end wall of the cylinder, the fluid tight gas chamber being defined by the bellows, the pressure plate and the end wall of the cylinder.

Advantageously, a longitudinal extent of each vessel may extend in an axial direction of the rotatable loop element. Alternatively, a longitudinal extent of each vessel may extend in a circumferential direction of the rotatable loop element. Furthermore, a longitudinal extent of each vessel may extend in a radial direction of the rotatable loop element.

Preferably, the power generating apparatus further comprises an endless arcuate support to which each vessel is mounted.

Beneficially, a plurality of individual said vessels is directly interconnected. In this case, the vessels may be pivotably interconnected. Furthermore, each vessel of the plurality of vessels may be similarly sized and/or shaped.

The power generating apparatus may further comprise a valve disposed at or proximate to a portal of the liquid chamber, the valve being operable to control ingress and/or egress of liquid into and/or out of the liquid chamber respectively for the purpose of providing or improving dynamic balancing of the entire rotating loop device by control of the gas-to-liquid ratio within each vessel at any given position on the rotating loop device. In this case, operation of the valve may be controllable by the movable separation means or by computer control means for dynamic balancing.

The movable separation means may operate the valve in a similar manner to a mechanical governor which automatically governs steam injection into a steam engine.

Furthermore, the valve is preferably closable when the volume of the gas chamber is at or substantially at a minimum.

The energy harvesting means may include a flow unit for harvesting energy using liquid flowing into the liquid chamber. Furthermore, the energy harvesting means may include a second said flow unit for harvesting energy using liquid flowing out of the liquid chamber. In these cases, the said first and/or second flow units may be at least one of mechanically, electrically and electro-mechanically operable.

Preferably, the energy harvesting means includes at least one piezo-electric device. Additionally or alternatively, the energy harvesting means may include at least one liquid turbine. In this latter case, the turbine may include an impellor adapted to rotate in one angular direction during liquid inflow, and in the same said angular direction during liquid outflow. Furthermore, the impellor preferably include a plurality of blades, and an impellor housing includes at least one liquid inlet/outlet, the blades being shaped to receive inflowing and outflowing liquid causing the in use impellor to rotate in the said same angular direction.

Preferably, the liquid inlet/outlet is an arcuate chute which curves from the exterior of the housing to meet or substantially meet the impellor. In this case, the arcuate chute curves at an advantageous or optimal flow angle. Conveniently, the arcuate chute may taper from partway therealong towards its respective ends. Furthermore, the power generating apparatus may further comprise hollow portions for the passage of ingressing liquid flow between the impellor shaft and the impellor blades, downstream of the impellor blades and upstream of the liquid chamber.

The power generating apparatus preferably further comprises hollow portions for the passage of liquid flow egressing the liquid chamber and passing over the turbine blades, the hollow portions being positioned between the impellor shaft and the impellor blades. The hollow portions are preferably near central parts of the impellor.

Additionally or alternatively, the hollow portions in conjunction with the impellor blades during ingressing and egressing fluid flow may cause the impellor to always rotate in the same rotational direction. In this case, a flywheel may be attached to the impellor shaft to maintain shaft momentum and direction while a said turbine is at or near the top and bottom of a loop rotation and liquid flow is in temporary stasis.

Energy is preferably outputable from a shaft of the impellor. Furthermore, an electrical power generator may be attached to the shaft of the impellor to generate power.

Preferably, the movable separation means includes a spring element, the energy harvesting means including a piezo-electric device provided with the spring element for outputting electrical energy on movement of the movable separation means.

Additionally or alternatively, the deep liquid container may define a depth which is no more than is required to enable the movable separation means to practically enable the gas chamber's internal volume to respond to changes in hydropressure when the loop element is rotated.

Furthermore, the deep liquid container may be a natural open body of deep liquid in which the loop element is positioned. Alternatively, the deep liquid container may be a manmade open body of stationary deep liquid in which the loop element is positioned. Furthermore, the deep liquid container may be a manmade fully enclosed body of stationary deep liquid in which the loop element is positioned.

Preferably, the deep liquid container is an enclosure fully housing the rotatable loop element, the deep liquid container and the rotatable loop element being held angularly stationary or substantially stationary relative to each other during rotation. In this case, the deep liquid container may be of at least substantially circular toroidal form. Alternatively, the deep liquid container may be of at least substantially elongate toroidal form.

The in use drive means may rotate the rotatable loop element at a velocity of in a range of 2 kph to 28 kph, whereby each vessel on the loop element may replicate the general volume of a great whale for vessels that may temporarily breach the liquid's surface. In this case, the said velocity is preferably substantially 4 kph for vessels that never breach the liquid's surface.

The drive means may beneficially be energisable using renewable energy. In this case, the renewable energy source is preferably remote from the apparatus.

The power generating apparatus may advantageously further comprise a harmonic drive gearing system interconnecting the drive means and the rotatable loop element. Furthermore, the energy harvesting means is preferably positioned at or adjacent to a surface of the deep liquid container, at or adjacent to the rotatable loop element.

According to a second aspect of the invention, there is provided a power generator comprising power generating apparatus in accordance with the first aspect of the invention, and a compressible gas, at least a portion of the deep liquid of the deep liquid container being receivable within the liquid chamber and the compressible gas being storable within the gas chamber.

Preferably, selection of the compressible gas is such that the gas chamber has minimal volume as the vessel of the rotatable loop element reaches the bottom of a rotational cycle. Furthermore, selection of the compressible gas may be such that the gas chamber has maximum volume as the vessel of the rotatable loop element reaches the top of a rotational cycle.

According to a third aspect of the invention, there is provided a method of generating power comprising the steps of providing a power generator in accordance with the second aspect of the invention when including a plurality of interconnected submersible vessels, rotating the rotatable loop element in the deep liquid of the deep liquid container, drawing liquid into each liquid chamber as each vessel descends on a rotational cycle and releasing said liquid out from each liquid chamber as each vessel ascends on the rotational cycle, the energy harvesting means using the liquid during release or once released to generate power.

Preferably, the energy harvesting means harvesting energy on the ascent and the descent of each said vessel. According to a fourth aspect of the invention, there is provided a method of generating power comprising the steps of providing a power generator in accordance with the second aspect of the invention when including a plurality of interconnected submersible vessels, rotating the rotatable loop element in the deep liquid of the deep liquid container, drawing liquid into each liquid chamber as each vessel descends on a rotational cycle, retaining said liquid within the liquid chamber as each vessel ascends on the rotational cycle and then releasing said liquid out from each liquid chamber as the vessel nears or reaches the point of maximum ascent, the energy harvesting means using the liquid during release or once released to generate power. Preferably, the liquid is retained in the liquid chamber by valve closure means closing a valve. Furthermore, the liquid is released from the liquid chamber by valve opening means opening the or a further said valve.

According to a fifth aspect of the invention, there is provided a method of generating power using power generating apparatus in accordance with the second aspect of the invention when including an endless movable separating member, the method comprising the steps of rotating the rotatable loop element, the energy harvesting means using a movement of the movable separation means during a rotational cycle to generate power.

Preferably, the deep liquid container is rotated together with the rotatable loop element.

According to a sixth aspect of the invention, there is provided power generating apparatus for use in conjunction with a deep liquid, the apparatus comprising an endless and at least in part rotatable loop element, drive means in communication with the endless loop element for rotating the endless loop element about a horizontal or substantially horizontal axis of rotation, and energy harvesting means, the endless loop element comprising a stationary or rotatable liquid chamber, a fluid-tight compressible and expandable gas chamber rotatable with or relative to the liquid chamber, and movable separation means separating the liquid chamber from the gas chamber, the in use movable separation means being at least partially movable in response to a change in hydropressure and the energy harvesting means harvesting energy as the movable separation means moves. According to a seventh aspect of the invention, there is provided a method of manufacture of power generating apparatus in accordance with the first and sixth aspects of the invention, wherein a density of a material used to form any one or more parts or whole of the deep liquid container, endless rotatable loop element, drive means, and energy harvesting means relative to the density of the chosen deep liquid in the deep liquid container is such that minimal drive input energy is necessary to rotate the endless rotatable loop element in or with the deep liquid.

The power generator is advantageous because it is able to exploit captured pressure obtained by the cooperating action of the liquid and gas chambers, and the movable separating means. This can occur by returning that captured pressure to the surface for use at the surface. Alternatively, the captured pressure that exists at any chosen depth of liquid, may be exploited for proximate ‘live’ and continuous conversion into mechanical energy and/or electrical power. Alternatively, the captured pressure may be immediately transferred away from the rotatable loop element preferably but not exclusively at or near the deep liquid's surface for use or storage, including by way of automated removal of an entire ‘compressed’ vessel for immediate automated replacement with an entire ‘uncompressed’ vessel. Alternatively, the movement of the movable separating means can be used to generate electricity, for example, using one or more piezo-electric devices.

Each rotatable loop element is able to store, release and generate power as the liquid and gas chambers cooperate, akin to lungs compressing and expanding, when the rotatable loop element rotates.

For each rotatable loop element, the depth of a portion of the rotatable loop element within a body of liquid decides the gas-to-liquid ratio of the liquid and gas chambers. The depth that the rotatable loop element reaches within the liquid is provided solely by rotation of the rotatable loop element driven by the drive means.

For each rotatable loop element, no internal energy input is required to provide diving conditions and no internal energy input is required to provide re-surfacing conditions.

For the invention, no internal volumes need to be assigned for life support systems within each rotatable loop element, allowing extremely efficient diving and re-surfacing energy to be externally provided by the drive means.

No energy consuming drive mechanisms need to be incorporated within each rotatable loop element to expel gas from the apparatus for descent on a rotational cycle or to expel liquid from the apparatus for the subsequent ascent. The rotatable loop element is provided with at least one ballast tank, i.e. the liquid and gas chambers and the movable separating means. Situated within each ballast tank is a volume of compressible gas contained within the gas-tight and liquid-tight gas chamber. As the portion of the rotatable loop element on the downward cycle descends in liquid, the external pressure from the liquid naturally increases and the volume of compressible gas is compressed. This action is naturally or slavishly and automatically achieved as the rotatable loop element passes through a rotational cycle.

It is important to note that the air pumps required to force air into a submarine's ballast tank for re-surfacing purposes and for removing air from a submarine's ballast tank for diving purposes are energy consuming devices. In stark contrast, the energy harvesting means of this invention include only passive devices that require no energy input other than the energy input required to drive the rotatable loop element.

The energy harvesting means may include any one or more of the following devices: levers, cranks, gearing, electrical generators and piezo-electric devices or springs. The energy harvesting means may be connected to external parts of preferably the gas chamber to provide for capturing and making use of the increasing and decreasing liquid pressure acting upon the gas chamber as each rotatable loop element rotates.

The invention provides a renewable energy source that is constant and not subject to the inconstant vagaries that befall renewable sources of energy such as wind, solar PV, tidal and wave energy sources, to generate power.

The invention provides a constant renewable energy source that can be exploited at a local (micro) level or at a large (macro) scale, providing little or no environmental impact, by commercially exploiting the long established Boyle's Law principles that deep-diving sea creatures naturally exploit—that liquid pressure remains directly proportional to depth and that pressure is measured by, and acts upon an area.

Means for capturing, storing and otherwise making use of liquid entering the ballast tank may be provided and may include mechanical, electrical or electro-mechanical devices for converting that incoming liquid into energy. For example, a turbine placed between a portal of the liquid chamber and the gas chamber may make use of the energy of the incoming water pressure before it is used to compress the gas chamber.

Means for capturing, storing and otherwise making use of the liquid exiting the ballast tank may likewise be provided and may include mechanical, electrical or electro-mechanical devices for also converting that outgoing liquid into energy.

Each vessel of the invention is optionally provided with a hydrodynamic outer body shape and/or hydro-friction reducing synthetic skin devices to further increase the hydrodynamic efficiency of sending a vessel down into deep liquid and efficiently bringing it to the surface again. For example, an outer surface of each vessel may be formed of or incorporate LZR Pulse®™ or a similar water repellent and laminar flow improving material of very fine microfibers of nylon and spandex in a high-density weave. Further outer panels, for example, of polyurethane may be laminated thereon.

It is envisaged that the invention may require a large priming motor to prime a new or recently maintained rotatable loop element, the priming motor being required for at least one complete revolution to prime and balance the entire rotatable loop element. Once the invention is rotating in its primed state, it is envisioned that the priming motor may automatically disengage, for example, in the manner of a conventional automatic Bendix gear which facilitates disengagement of a starter motor from an internal combustion engine, after the engine has been primed and started.

It is also envisaged that, after priming, the rotatable loop element may be maintained at a chosen efficient rotation speed by use of a low energy motor continuously driving the rotatable loop element, for example, by use of a conventional harmonic drive gearing system.

Other drive means may also be additionally or alternatively considered. For example, air may be introduced at depth into one or more receiving chambers in or on the vessel. The air may be piped into the deep liquid to be discharged in or adjacent to the vessels as they rotate. The discharging air is captured by the receiving chamber of each vessel, increasing the buoyancy of each vessel. The air is thus discharged from each receiving chamber as the respective vessel reaches or passes the top of the rotatable loop element.

Furthermore, the drive means may additionally or alternatively be formed at least in part from gas discharged from undersea fissures, such as in the case of submarine volcanos. By funnelling the discharged gas to the receiving chambers of the vessels, again, buoyancy is achieved enabling a rotational drive to be imparted to the rotatable loop element.

The body or reservoir of liquid may be separate from the rotatable loop element or permanently stored therewithin.

In each vessel of the invention, an optional liquid-tight third chamber for enclosing electrical generation equipment and/or an optional liquid-tight fourth chamber for safely transferring generated electricity away from the apparatus may be provided.

The rotatable loop element may be generally elongate or circular in general form. Adjacently arranged vessels may be associated with each other by either flexible or rigid conventional linking devices and/or they may be attached to an annular support.

Each vessel of the invention has at least one portal for facilitating the flow of liquid into the liquid chamber. Each portal may also constitute a liquid outlet. Alternatively, a separate liquid outlet may be provided.

Each portal may optionally be provided with a portal valve that is configured to automatically close when the vessel is at or near the bottom-most part of the rotational cycle, to facilitate delivery of the captured volume of liquid to the surface. At or near the top-most part of the rotational cycle, since the portal valve is configured to automatically open, the captured volume of liquid is released under pressure, as the gas chamber that was compressed by the deep liquid pressures at the bottom-most part of the cycle, is suddenly allowed to re-expand. The release of the captured volume of liquid may include jetting the liquid from the vessel to drive conventional devices such as water-wheels and water turbines. After the liquid has been exhausted from the liquid chamber, the vessel is ready to begin its descent into the deep liquid once again.

Alternatively, the portal of a vessel may not be provided with a portal valve. In this option, as the vessel begins its ascent, the gas chamber is obliged to re-expand as the liquid pressure decreases with liquid exiting through the portal. Again, after the liquid has been exhausted from the liquid chamber, the vessel on the rotatable loop element is ready to begin its descent into the deep liquid once again.

The deep liquid itself may be any suitable liquid such as water, oil, bleach, or other liquid industrial chemicals of a suitable nature. There may be commercial circumstances where the rotatable loop element may need to be non-hydrodynamic; for example where agitation of a deep liquid is a requirement.

The rotatable loop element may be considered for use within three separately definable deep liquid environments as described below.

A first environment is defined as an open body of liquid, including an ocean, lake or reservoir.

A second environment is defined as an enclosed body of liquid having an optionally open surface, including a bore-well, adapted mine shaft, adapted lift shaft and a specially manufactured vessel for containing a deep liquid for use with the invention.

A third environment is defined as a fully enclosed deep-liquid holding vessel that is specially manufactured for, preferably though not exclusively, being adjoined to the rotatable loop element for rotation with the vessels to form a single, fully enclosed rotating unit. Such a rotating unit may preferably but not exclusively be of a toms form.

Each vessel may be adjacently positioned and similarly aligned with respect to a similar sized neighbouring vessel such that a plurality of such vessels forms a rotatable loop element for continuous rotation in a liquid reservoir.

Each vessel contains at least one separate compressible gas chamber, whose internal volume may be rated as ‘maximum’ when said vessel is at or near the top-most part of the rotational cycle as the rotatable loop element rotates in a deep liquid and whose internal volume may be rated as ‘minimum’ when said vessel is at or near the bottom-most part of the rotational cycle.

The outer profile of each vessel may preferably, but not essentially be of hydrodynamic form for best laminar flow of the deep liquid over the vessels of the rotatable loop element as rotation of the rotatable loop element continuously causes vessels to descend and ascend.

The volume of the compressible gas contained within the gas chamber is significantly reduced during descent of the vessel, due to liquid flowing into the liquid chamber. The liquid entering the portal acts to compress the gas within the gas chamber.

Conversely, the volume of the compressible gas contained within the gas chamber is significantly increased during ascent of the vessel in the liquid reservoir, due to liquid flowing out from the liquid chamber. Since there is less liquid in the liquid chamber, the gas within the gas chamber is able to re-expand.

Valve means are optionally provided to prevent liquid from leaving the vicinity of a gas chamber during a vessel's ascent phase, thus preventing gas chamber re-expansion.

In an alternative to the above, the volume of the compressible gas contained within the gas chamber is significantly reduced during descent of the vessel, due to the increasing pressure of the deep liquid acting directly upon a gas chamber. Conversely, the volume of the compressible gas contained within the gas chamber is significantly increased during ascent of the vessel, due to the decreasing pressure of the deep liquid acting directly upon a gas chamber.

From the information disclosed so far, it should be thus apparent that continuous rotation of the rotatable loop element in a liquid reservoir is commercially advantageous as it facilitates harvesting the considerable liquid pressure differentials that exist at all depths of a deep liquid.

Such continuous capture and continuous use of the considerable liquid pressure differentials found at different levels in a deep liquid may be novelly, advantageously and significantly commercialised by harvesting the increasing and decreasing liquid pressure forces that are naturally exerted on the outer structure of the gas chamber of the invention as the rotatable loop element passes through a rotational cycle.

Additionally, as each vessel descends, inflow of liquid through the portal from the deep liquid into the liquid chamber may optionally be first directed onto, for example, turbine blades, for harvesting the energy of a turbine optionally installed within said vessel, for generating electrical current, before the liquid is then able to enter the liquid chamber.

Similarly, as each vessel ascends, outflow of liquid from a liquid chamber may be first directed onto, for example, turbine blades, for harvesting the energy of a turbine optionally installed within said vessel, for generating electrical current, before the liquid is then able to enter said portal for return to the deep liquid.

Such harvesting may include the attachment of mechanical devices for generating electricity using, for example, conventional dynamos, magnetos, and alternators.

Such harvesting may also include the attachment of mechanical devices for generating electricity using, for example, piezo-electric springs and other piezo-electric devices.

Such harvesting may also include the attachment of mechanical devices for generating mechanical force for, for example, liquid-jetting onto conventional devices such as water-turbines, water wheels and flywheels.

Such harvesting may additionally include the attachment of mechanical devices for the sequential release of the pressurised liquid that may optionally be contained inside a vessel's liquid chamber, for capture and containment at or near the bottom of a rotational cycle and for release as the vessel nears the surface of a deep liquid, for jetting that liquid to a separate liquid tank set at a higher level than the surface of the deep liquid.

Such harvesting may additionally include the removal of a pressurised liquid containing vessel at or near the top of a loop for immediate automatic replacement with an empty vessel.

In the invention, the gas chamber installed within each vessel may have the structural resemblances of a bladder or lung, a chest-type or rib-type structure containing a lung, a piston-in-cylinder device or an amalgam of two or more such structural resemblances.

For each type of compressible gas chamber, means are provided to ensure that the said gas chamber is both gas-tight and liquid-tight.

In a latched embodiment of the vessel, each gas chamber may be latched shut at high compression using a valve, at or near the bottom of the rotational cycle, for locking the pressure stored within, as each vessel ascends. At or near the surface, each vessel may be sequentially de-latched, whereupon the pressurised gas may be used to force the liquid surrounding the compressible vessel to be sequentially jetted from each vessel, for continuous driving of mechanical generators, electrical generators or other uses.

Also in the latched embodiment, each compressible gas chamber may be provided with piezo-electric spring devices that are obliged to stress as the volume of each descending gas chamber is obliged to compress.

In a non-latched embodiment, the invention comprises a plurality of similar, adjacently positioned vessels that together form a rotatable loop element. A vessel positioned near the surface of a deep liquid has at least one compressible lung or bladder device that may be fully expanded prior to descent.

As the vessel begins its decent into the deep liquid, the compressible lung begins to compress, by action of increasing external liquid pressure from the deep liquid entering the first chamber of the vessel via an access portal and forcing, for example, a piston to compress the gas chamber. As the vessel reaches its deepest required depth, the vessel's second chamber is desirably fully compressed. When the vessel begins its ascent to the surface, the second chamber begins to re-expand, forcing liquid from the first chamber, via the portal, back to the liquid reservoir. At or near the surface, the vessel's second chamber is again fully expanded.

Energy harvesting means, preferably in communication with the separating means, may, at all positions on the rotatable loop element, drive, for example, turbines or piezo electric devices, to provide electrical power. Thus, an array of vessels, adjacently or proximately placed to form a rotatable loop element, provides a consistent and sequential output of electrical power.

In a further latched embodiment, the invention also comprises a plurality of similar, adjacently positioned vessels that together form a rotatable loop element. A vessel positioned near the surface of a deep liquid has at least one compressible lung device that is preferably fully expanded prior to descent.

As the vessel begins its decent into the deep liquid, the compressible lung begins to compress, by action of increasing external liquid pressure from the deep liquid entering the liquid chamber via the access portal and forcing a piston to compress the gas chamber.

As the vessel reaches its deepest required depth, the compressible gas chamber is desirably fully compressed, whereupon a piston-latch device may engage with the piston. Thus, when the vessel begins its ascent to the surface, the piston-latch prevents re-expansion of the gas chamber, thereby maintaining pressure in the gas chamber and also maintaining a significant volume of liquid in the liquid chamber.

At or near the surface, the latch mechanism on the vessel may be released, providing near-surface means for using the energy that is still stored behind the piston in the fully compressed second chamber to forcibly eject the liquid from the liquid chamber. This ejected liquid may drive a turbine or a piston connection rod to drive one or more electrical or mechanical devices. Alternatively, the ejected liquid may be transmitted to a higher level than the surface of the deep liquid in which the rotatable loop element rotates for subsequent use or storage.

In a further non-latched embodiment, the invention comprises a plurality of similar, adjacently positioned vessels that together form a rotatable loop element. A vessel positioned near the surface of the deep liquid has at least one compressible lung device that may be fully expanded prior to descent.

As the vessel begins its descent into the deep liquid, the compressible lung begins to compress, by action of increasing external liquid pressure from the deep liquid entering the first chamber and forcing, for example, a piston to compress the gas chamber. As the vessel reaches its deepest required depth, the compressible lung's gas chamber is desirably fully compressed.

When the vessel begins its ascent to the surface, the gas chamber begins to re-expand, forcing liquid from the liquid chamber, via the portal, back to the liquid reservoir. At or near the surface, the vessel's gas chamber is again fully expanded.

Energy harvesting means, in the form of various devices, are attached to preferably the outer portions of the compressible and expandable piston device for converting mechanical energy into electrical energy. For example, these could be spring-like piezo-electric generators or any other suitable conventional devices that stress and de-stress at all descending and ascending positions on the rotating rotatable loop element.

Devices, including turbines, may also be attached to or positioned within the inner parts of the liquid chamber for first directing incoming liquid from the deep liquid, as a vessel descends, onto the blades of a turbine impellor rotating a turbine before the liquid is allowed to enter the liquid chamber to compress the gas chamber. Conversely, as a vessel ascends, the re-expanding gas chamber may oblige the liquid in the liquid chamber to again first drive the blades of the turbine in the same direction before the outgoing liquid is allowed to re-enter the deep liquid.

Thus, an array of such non-latched vessels, adjacently placed to form a rotatable loop element provides a consistent and sequential output of electrical power. In an alternative, an array of such non-latched vessels, having their gas chambers conjoined to form a single chamber within said array, also provides a consistent and sequential output of electrical power.

Also in the further non-latched embodiment, each gas chamber may be provided with piezo-electric devices that are obliged to stress as the volume of each descending gas chamber is obliged to compress and are obliged to de-stress as the volume of each ascending gas chamber is obliged to re-expand.

In a yet further non-latched embodiment, the invention comprises a plurality of similar, adjacently positioned vessels that together form a rotatable loop element. A vessel positioned near the surface of a deep liquid has at least one compressible piston device that is typically fully expanded prior to descent.

As the vessel begins its decent into the liquid reservoir, the piston begins to compress the gas chamber, by action of increasing external liquid pressure from the deep liquid entering a liquid chamber of the piston via an access portal. As the vessel reaches its deepest required depth, the gas volume is desirably fully compressed.

When the vessel begins its ascent to the surface, the gas chamber begins to re-expand, forcing against the piston and forcing liquid from the liquid chamber, via the portal, back to the volume of deep liquid. At or near the surface, the gas chamber is again fully expanded.

Energy harvesting means, in the form of various devices, are attached to preferably the outer portions of the compressible and expandable piston device for converting mechanical energy into electrical energy. For example, these could be for piezo-electric springs or any other suitable piezo-electric device that stresses and de-stresses at all descending and ascending positions on the rotating rotatable loop element.

Devices, including turbines, may also be attached to the inner parts of the liquid chamber for first directing incoming liquid from the deep liquid, as a vessel descends, onto the blades of a turbine impellor for rotating a turbine before the liquid is allowed to enter the liquid chamber for compressing the gas chamber. Conversely, as the vessel ascends, the re-expanding gas chamber may oblige the liquid in the liquid chamber to again first drive the blades of the turbine in the same direction before the outgoing liquid is allowed to re-enter the liquid reservoir. Thus, an array of such non-latched vessels, adjacently placed to form a rotatable loop element provides a consistent and sequential output of electrical power.

Also in the yet further non-latched embodiment, each gas chamber may be provided with piezo-electric devices that are obliged to stress as the volume of each descending gas chamber is obliged to compress.

Additional means for improving the dynamic balancing of the looping devices may include valve means for aiding or restricting liquid movement within the looping device and best use of various materials densities during construction to replicate the efficient means by which submarines and great whales subtly change displacement ratios for best diving and re-surfacing needs.

For a better understanding of the present invention, and to show more clearly how it may be carried into effect, reference will now be made, by way of example only, to the accompanying drawings, in which:

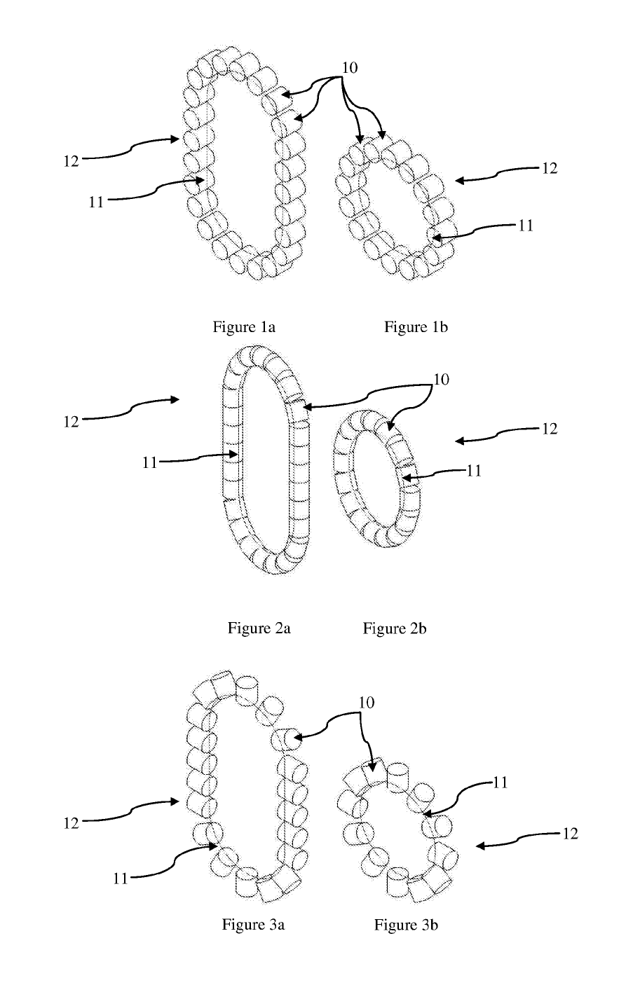

FIG. 1a shows a perspective view of a first arrangement of a rotatable loop element forming part of a first embodiment of power generating apparatus in accordance with the invention, and shows in particular an elliptical rotatable loop element, with a longitudinal extent of each vessel of the invention extending in the axial direction of the rotatable loop element;

FIG. 1b shows a perspective view of a second arrangement of the rotatable loop element, similar to the rotatable loop element of Figure la save for the rotatable loop element being circular;

FIG. 2a shows a perspective view of a third arrangement of the rotatable loop element, with the rotatable loop element being elliptical and the longitudinal extent of each vessel extending in the circumferential direction of the rotatable loop element;

FIG. 2b shows a perspective view of a fourth arrangement of the rotatable loop element, similar to the rotatable loop element of FIG. 2a save for the rotatable loop element being circular;

FIG. 3a shows a perspective view of a fifth arrangement of the rotatable loop element, with the rotatable loop element being elliptical and with the longitudinal extent of each vessel extending in the radial direction of the rotatable loop element;

FIG. 3b shows a perspective view of a sixth arrangement of the rotatable loop element, similar to the rotatable loop element of FIG. 3a save for the rotatable loop element being circular;

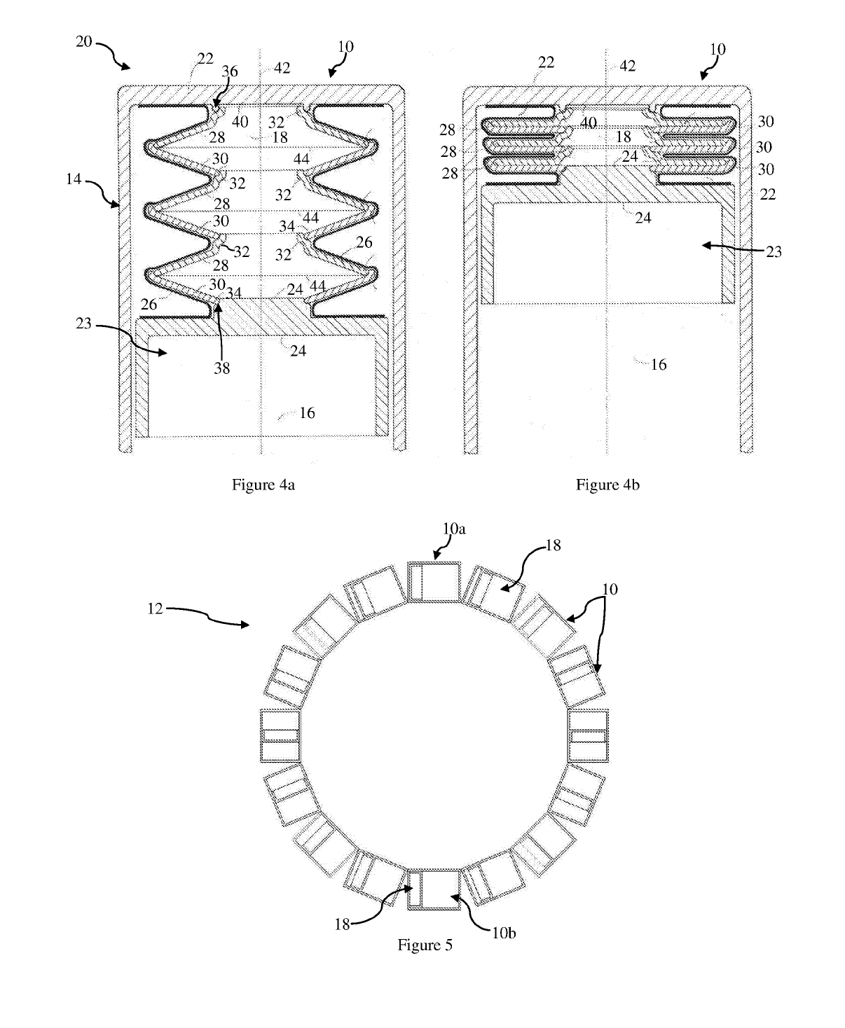

FIG. 4a shows a cross-sectional view of one embodiment of a vessel forming part of the rotatable loop element of the first embodiment of the power generating apparatus, and shows in particular liquid and gas chambers and an intermediate separating means provided in the form of a first embodiment of a piston/cylinder system, with the gas chamber shown in an expanded condition;

FIG. 4b shows a cross-sectional view of the piston/cylinder system of FIG. 4a, with the gas chamber in a compressed condition;

FIG. 5 shows a schematic side view of vessels incorporating the non-latched piston/cylinder system of FIGS. 4a and 4b in situ around the circular rotatable loop element of FIG. 2b, and shows in particular how a ratio of volumes of the liquid and gas chambers varies around the descent/ascent cycle;

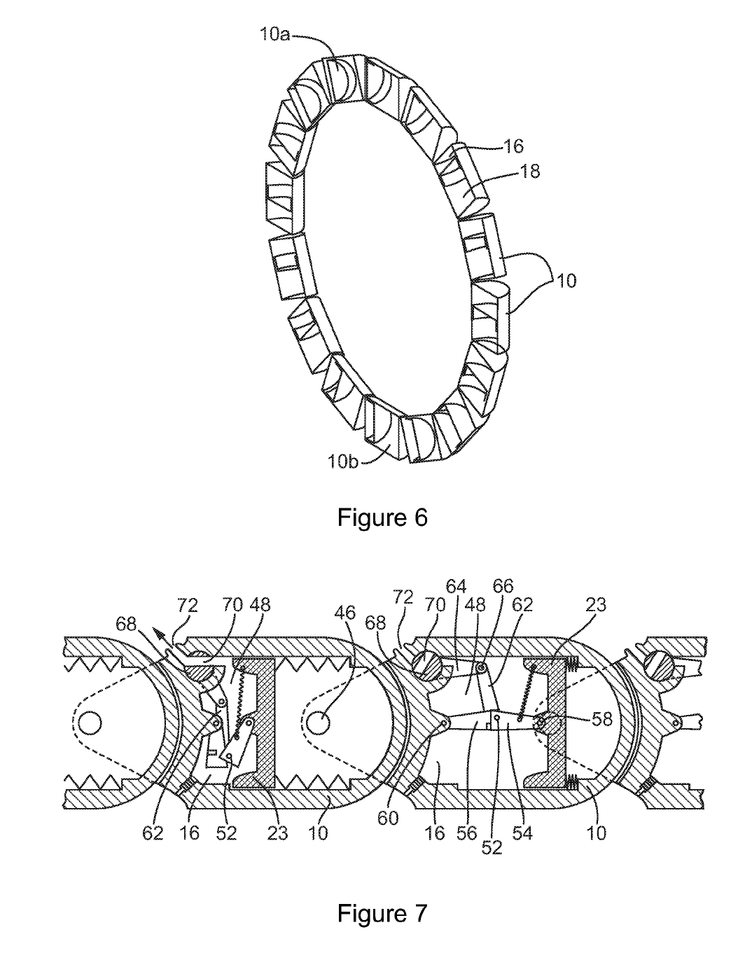

FIG. 6 shows a longitudinal cross-sectional perspective view of the vessels of FIG. 5;

FIG. 7 shows a longitudinal cross-sectional view of a second embodiment of the said piston/cylinder system and incorporating a latching mechanism;

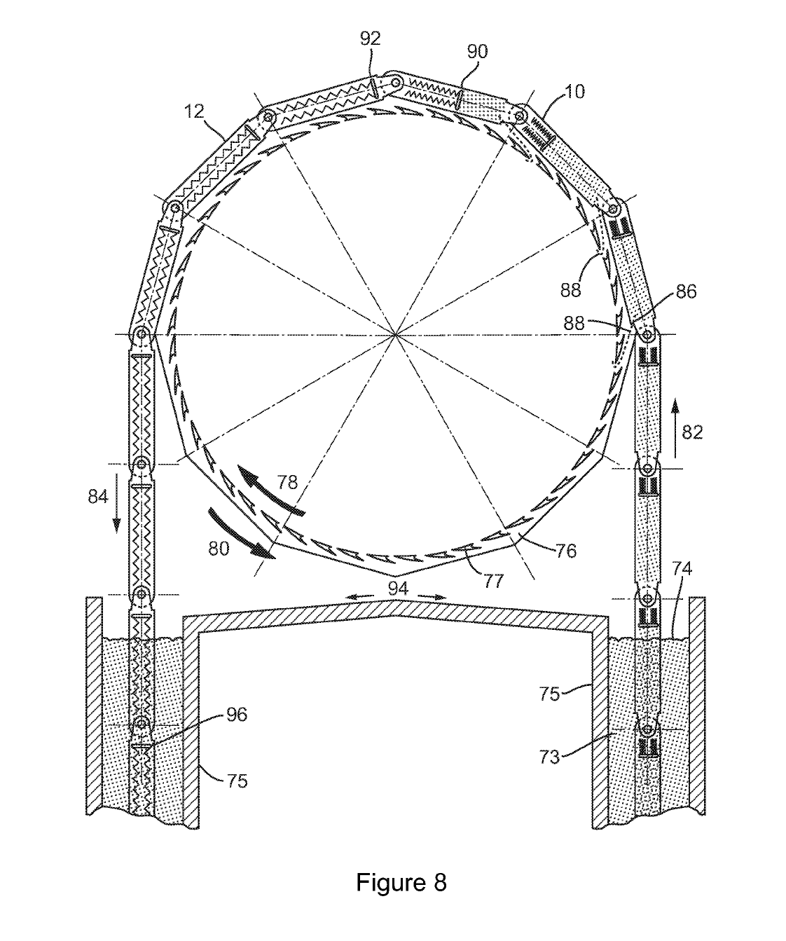

FIG. 8 shows an enlarged schematic front view of part of a power generator in accordance with the second aspect of the invention in use, with an elongate rotatable loop element of vessels passing through a V-shaped volume of deep liquid and arranged generally in accordance with the third arrangement shown in FIG. 2a;

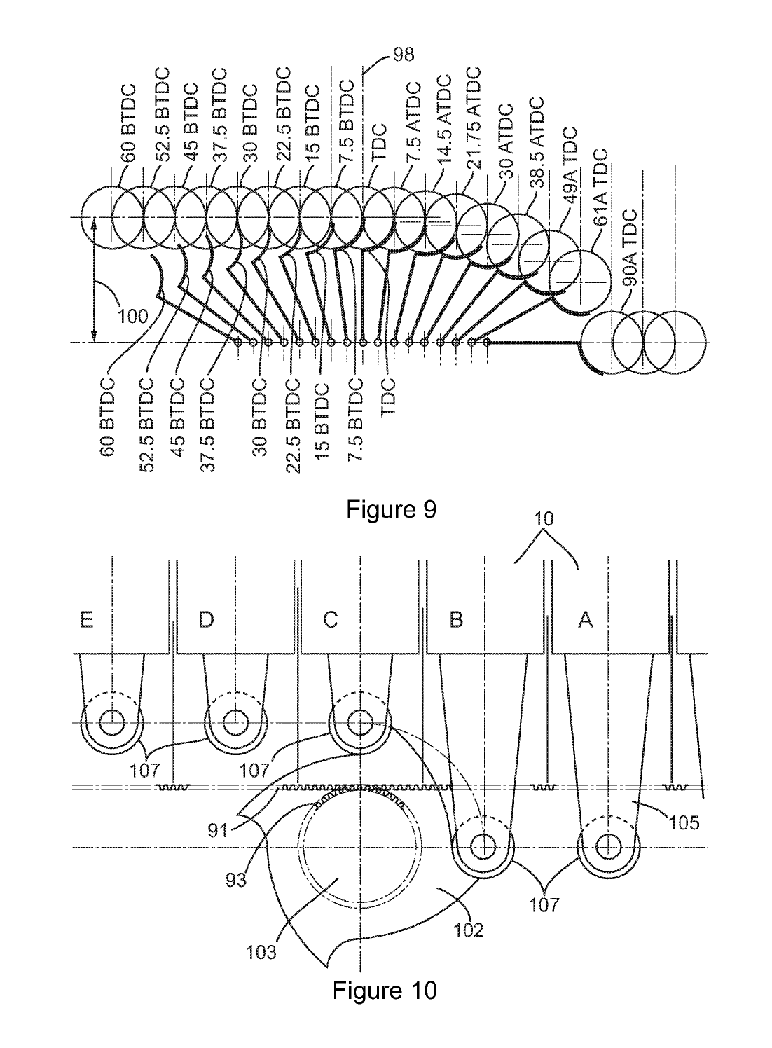

FIG. 9 shows schematically the various latched and de-latched positions of a piston rod-end in the second embodiment of the piston/cylinder system of FIG. 7 relative to a cylinder according to the position of the vessel as it nears the top part of a rotational cycle;

FIG. 10 shows a schematic of a piston engine of the first embodiment of the power generating apparatus;

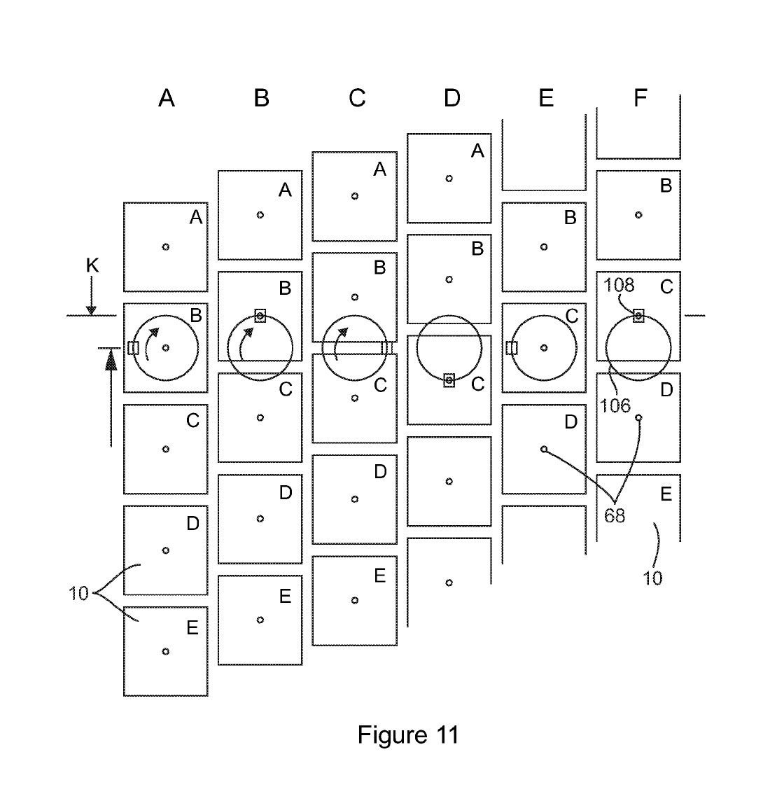

FIG. 11 provides a diagrammatic plan view of a further unlatching mechanism used for sequentially de-latching latched vessels near the top of the part of the rotational cycle;

FIG. 12 is an isometric view showing one half of a turbine impellor forming part of a further arrangement of the vessel with directional casing chutes, with liquid flowing into the liquid chamber;

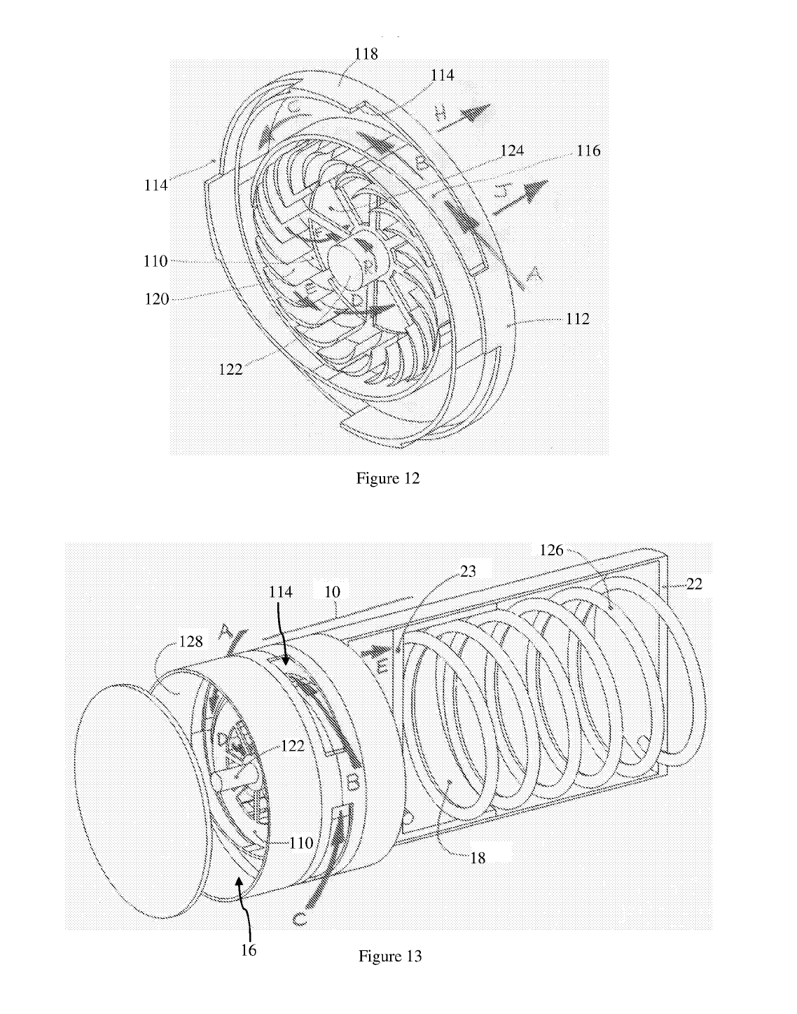

FIG. 13 is an isometric cutaway view showing the full turbine impellor of FIG. 12 installed in a ‘piston-in-cylinder’ vessel, again with liquid flowing into the liquid chamber;

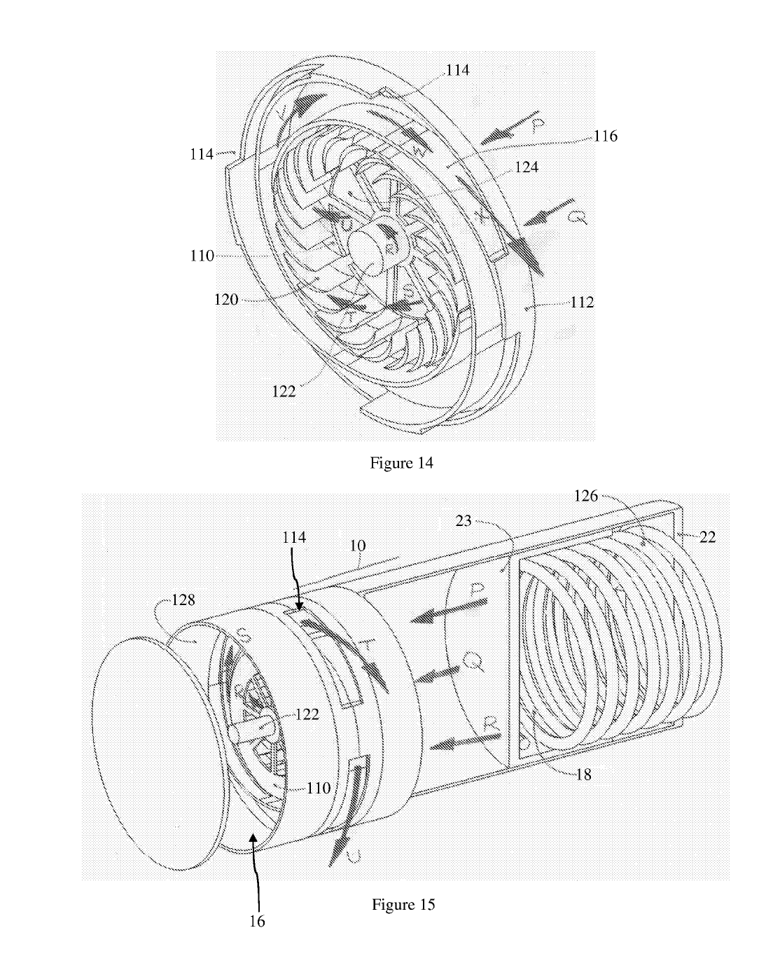

FIG. 14 is an isometric view showing one half of the turbine impellor shown in FIG. 12, with liquid flowing out from the liquid chamber;

FIG. 15 is an isometric cutaway view showing the full turbine impellor of FIG. 12 installed in a ‘piston-in-cylinder’ vessel, again with liquid flowing out from the liquid chamber;

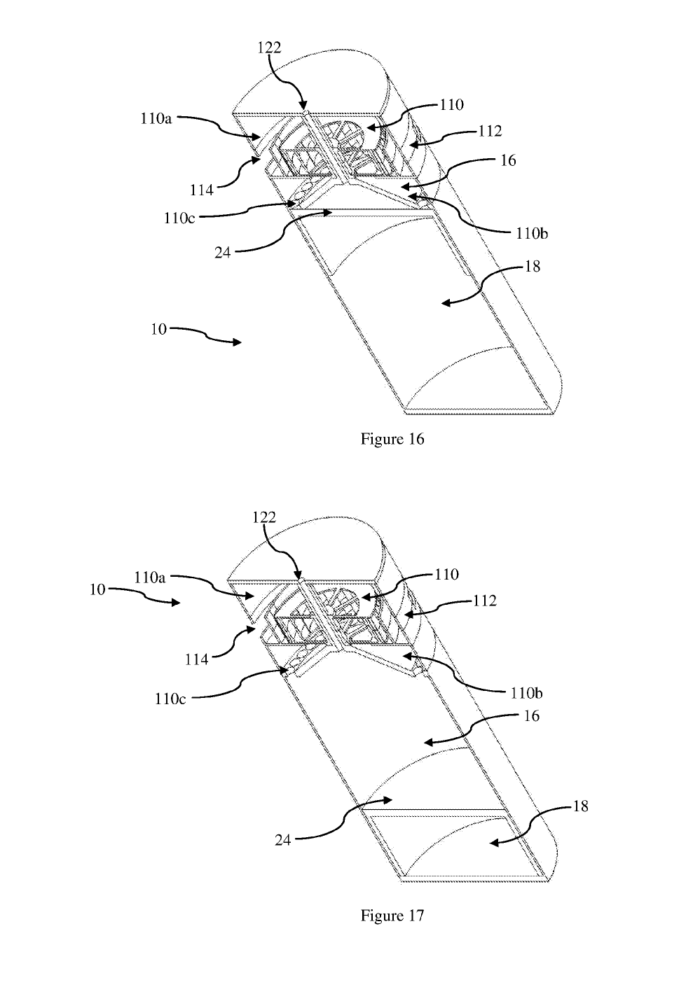

FIG. 16 shows a cross-sectional isometric view through the elongate axis of the piston-type vessel when near the top of a rotational cycle, and with the gas chamber fully expanded;

FIG. 17 shows a cross-sectional isometric view through the elongate axis of the piston-type vessel near the bottom of the rotational cycle, and with the gas chamber fully compressed;

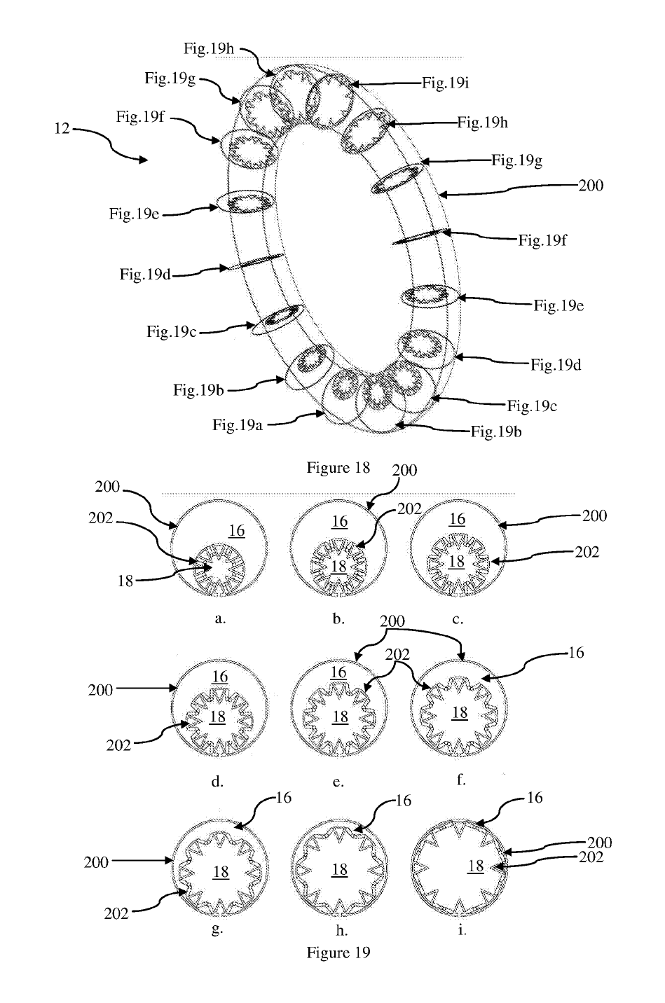

FIG. 18 shows a perspective view of a second embodiment of power generating apparatus, in accordance with the invention and including a further arrangement of a rotatable loop element having a first example of a collapsible lung system as opposed to a piston/cylinder system;

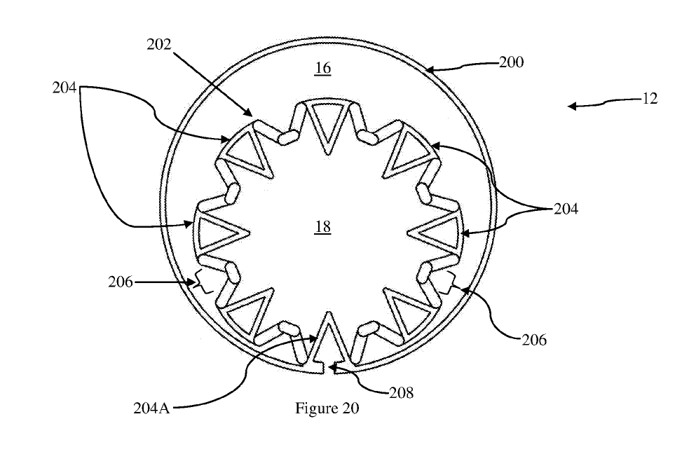

FIGS. 19a to 19i provide an indication of the size of an expansion/contraction member or diaphragm of the invention at various positions around the rotational cycle of the rotatable loop element, with position 19a corresponding to a position at the bottom of the rotational cycle and position 19i corresponding to a position at the top of the rotational cycle;

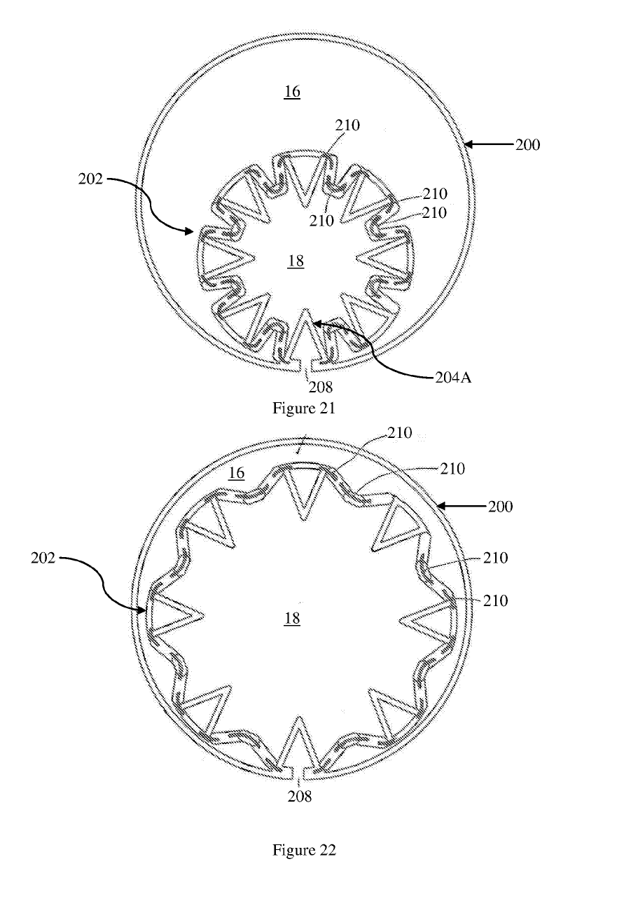

FIG. 20 shows an enlarged cross-sectional view of the expansion/contraction member at the position indicated in FIG. 19f.

FIG. 21 is a cross sectional view as generally seen at position c in FIG. 19 with the expansion/contraction member in a generally compressed state, but representatively shown to include a piezo-electric generator;

FIG. 22 is a cross sectional view as generally seen at position h in FIG. 19 with the expansion/contraction member in a generally expanded state, but representatively showing the piezo-electric generator;

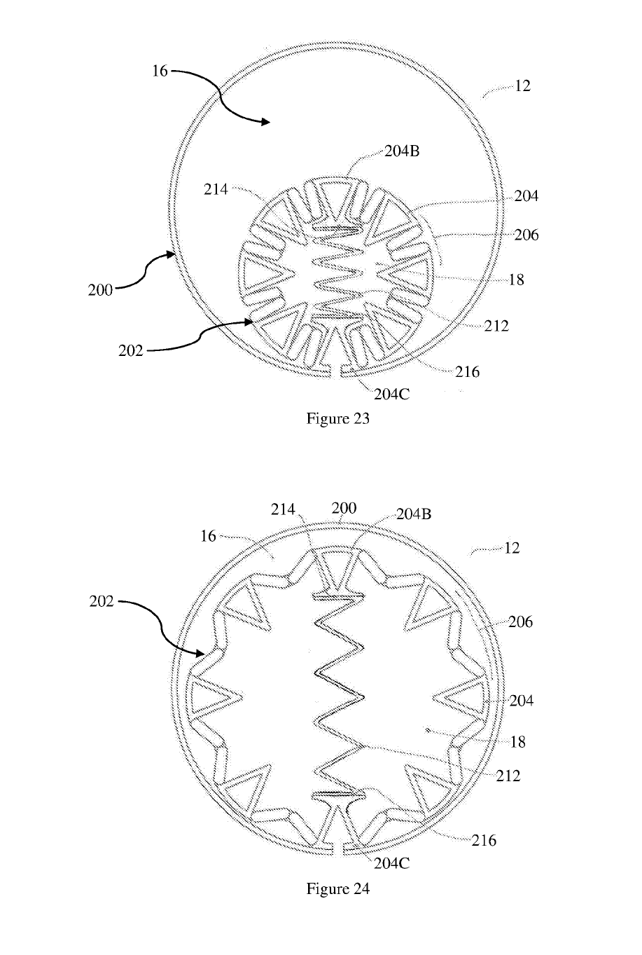

FIG. 23 is a schematic cross sectional view of a modified version of the expansion/contraction member in an almost fully compressed state, in which a spring-like piezo-electric generator is provided within the gas chamber;

FIG. 24 is a cross sectional view of the modified version of the expansion/contraction member of FIG. 23, but with the piezo-electric generator in an almost fully expanded state;

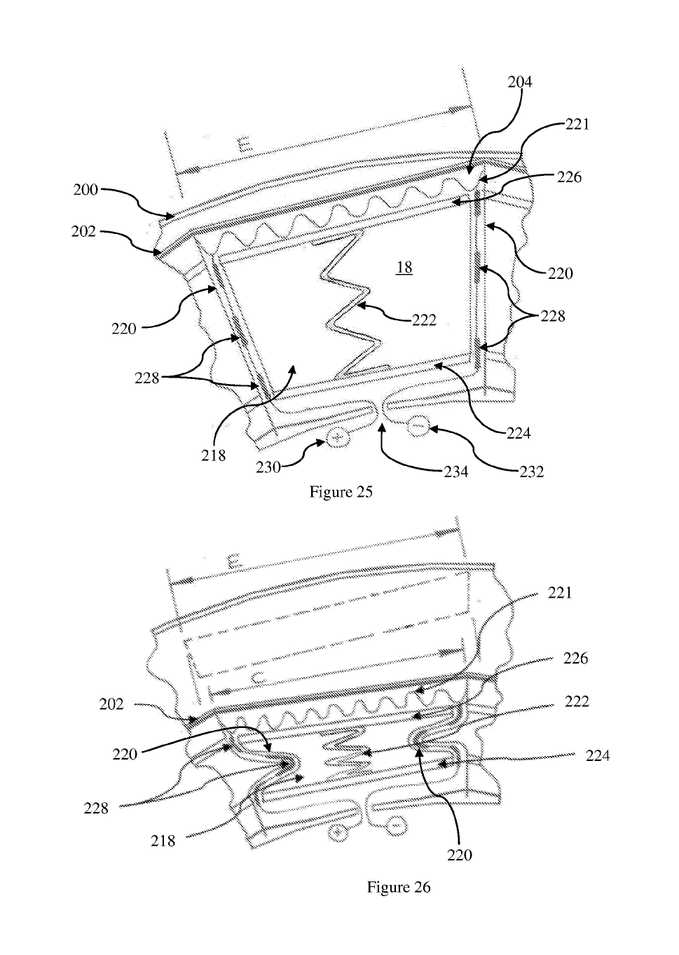

FIG. 25 shows an enlarged partial cross-sectional front view of part of an expansion/contraction member of a second example of a collapsible lung system, in its fully expanded state near the top of the rotational cycle;

FIG. 26 shows a sectional partial front view of the second example of the collapsible lung system of FIG. 25, now in its fully compressed state near the bottom of a rotational cycle;

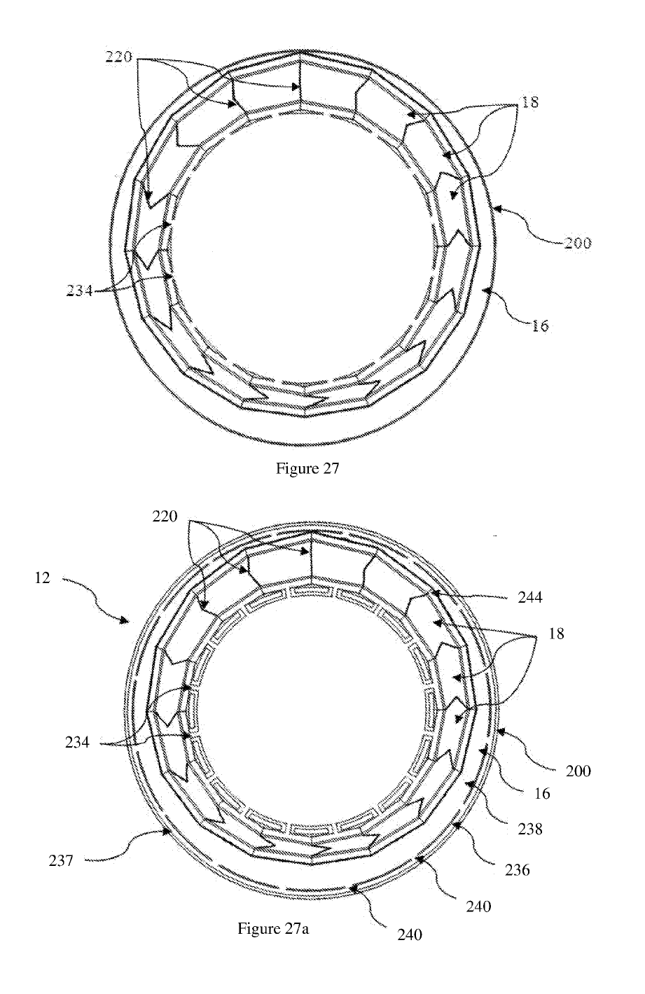

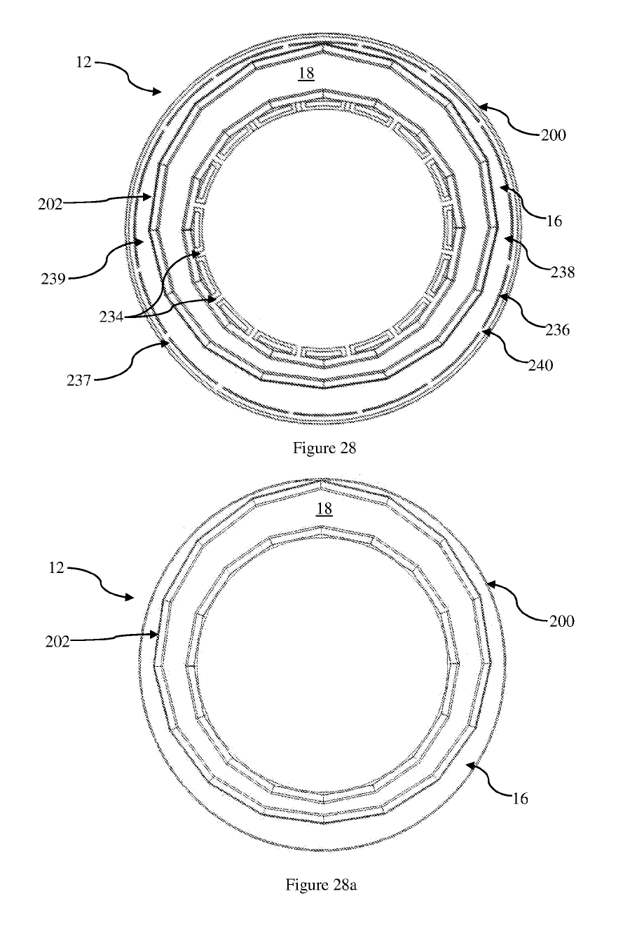

FIG. 27 shows a complete sectional front view of sixteen gaiter separated compartments of the second example of the collapsible lung system detailed in FIG. 25 and FIG. 26, and in particular an inner toms radially surrounding the expansion/contraction member;

FIG. 27a is similar to FIG. 27 but showing a second arrangement of the second example of the collapsible lung system;

FIG. 28 shows a complete sectional front view of a third arrangement of the second example of the collapsible lung system, similar to FIG. 27a but with the internal gaiters removed to form a single circular or substantially circular expansion/contraction member;

FIG. 28a is similar to FIG. 28, and shows a fourth arrangement of the second example of the collapsible lung system;

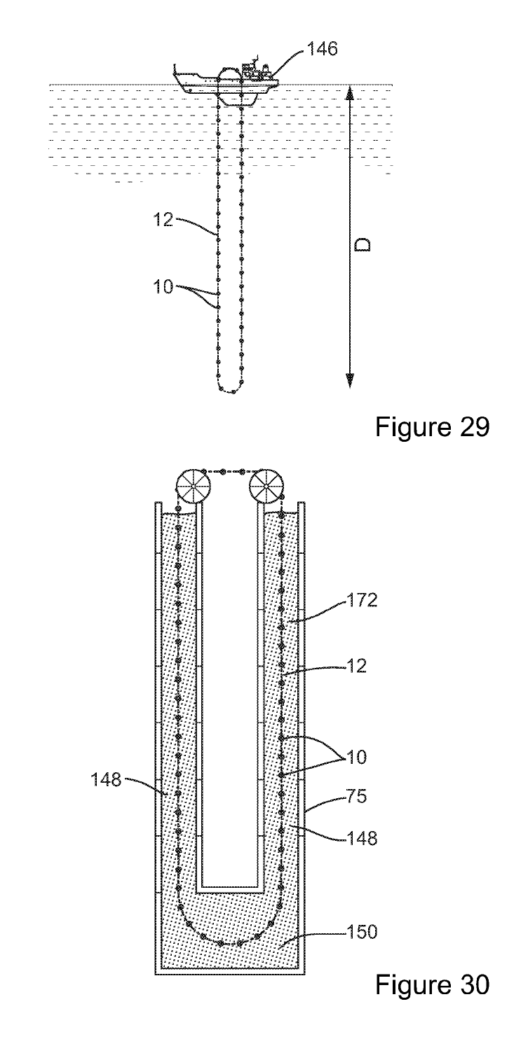

FIG. 29 provides a diagrammatic example of the rotatable loop element of the first or second embodiments in operation in a natural open body of deep liquid;

FIG. 30 provides a diagrammatic example of the rotatable loop element of the first or second embodiments in operation in a “man-made” or constructed open body of deep liquid;

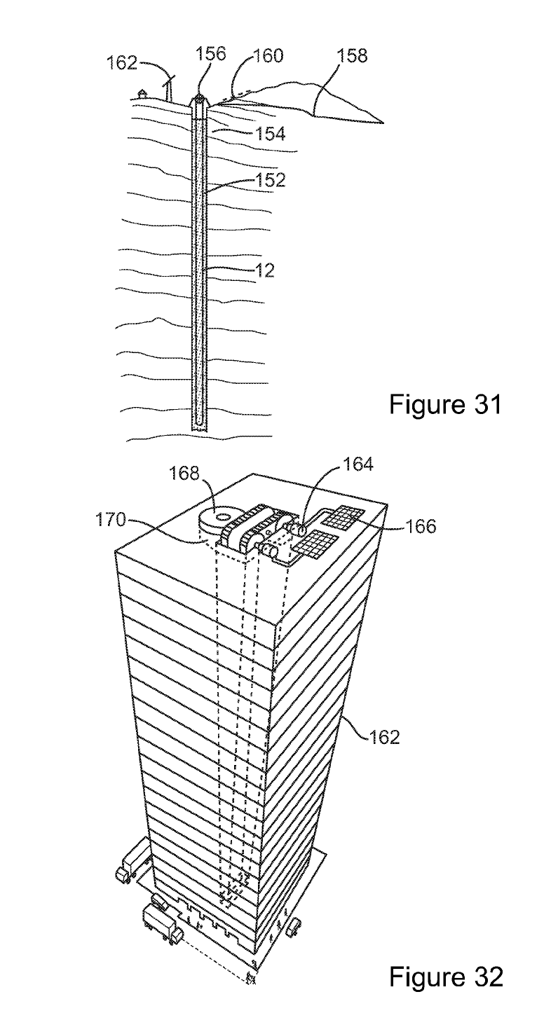

FIG. 31 provides a diagrammatic representation of the rotatable loop element of the first or second embodiments in operation in a further constructed open body of deep liquid;

FIG. 32 shows a perspective view from above of the rotatable loop element of the first or second embodiments installed in a building;

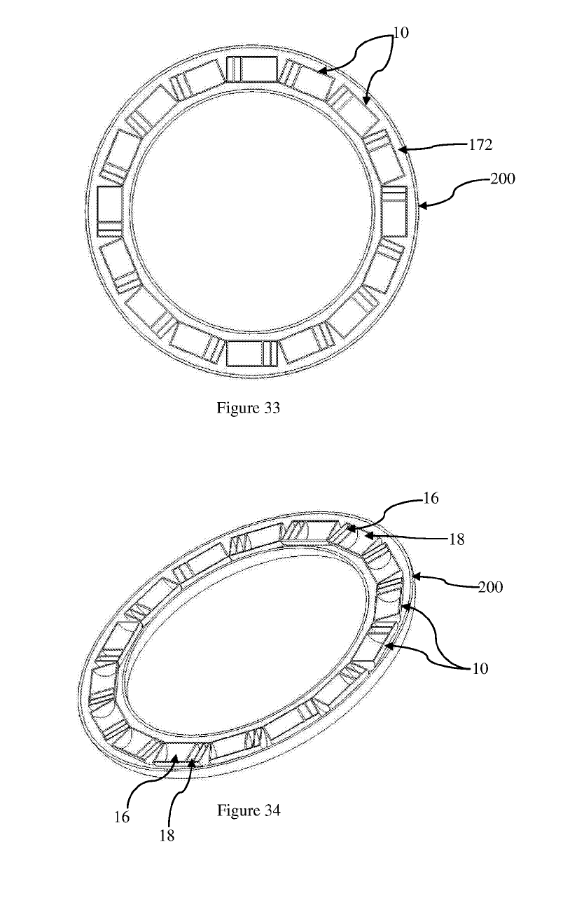

FIG. 33 is a further embodiment of at least part of power generating apparatus in accordance with the invention, and showing a lateral cross-sectional view through a rotational axis of the vessels of FIGS. 5 and 6 set within a fully enclosed body of deep liquid; and

FIG. 34 shows a lateral cross-sectional isometric view through a rotational axis of the vessels of FIG. 33.

A power generator that in use is at least partially submerged in a reservoir of liquid is described hereafter. In a first embodiment, the power generator includes a plurality of interconnected vessels 10 forming an endless loop / rotatable loop element 12 or a plurality of vessels 10 mounted to a support structure 11. To clarify, throughout this specification, the term “rotatable loop element” is used simply to refer to either a plurality of interconnected vessels 10 or a single vessel 10 for forming an endless loop or to vessels 10 mounted to a preferably annular support structure 11 or to a toroidal expandable/contractible member located within a housing (described in more detail later).

FIGS. 1a, 1b, 2a, 2b, 3a and 3b indicate various arrangements of the rotatable loop element 12. The rotatable loop element 12 may be elliptical or elongate as indicated in FIGS. 1a, 2a and 3a, or it may be circular, as indicated in Figures lb, 2b and 3b.

The longitudinal extent of each vessel 10 may be aligned in parallel with the longitudinal extent of an adjacent vessel 10, as indicated in Figures la and lb. In this arrangement, the longitudinal extent of each vessel 10 extends along the axial direction of the rotatable loop element 12.

Alternatively, each vessel 10 may be arranged end-to-end around the rotatable loop element 12, as indicated in FIGS. 2a and 2b. In this arrangement, the longitudinal extent of each vessel 10 extends along the circumferential direction of the rotatable loop element 12.

As a further alternative, the longitudinal extent of each vessel 10 may be perpendicular or substantially perpendicular to the movement path of the rotatable loop element 12, as indicated in FIGS. 3a and 3b. In this arrangement, the longitudinal extent of each vessel 10 extends along the radial direction of the rotatable loop element 12.

In a further alternative, the longitudinal extent of each vessel 10 may be positioned at any beneficial angle that lies between any two of the axial, circumferential and radial directions.

Each vessel 10 is generally preferably cylindrical in form, having a circular lateral cross-section. It is envisaged that other suitable forms of vessel 10 may be used and these may have non-circular lateral cross-sections.

Each vessel 10 comprises a main body or housing 14 having a liquid chamber 16 for receiving liquid from a reservoir via portal access through the vessel's main body 14 and a gas chamber 18 that is fluid-tight for maintaining a volume of compressible gas at various volumes with respect to the external pressure exerted upon it by the liquid entering the liquid chamber 16.

The gas chamber 18 and the liquid chamber 16 are separated by separating means, which may take the form of, for example, a bladder or lung, or a piston/cylinder system.

FIGS. 4a and 4b show sectional side views through the common longitudinal axis of a group of co-operating components belonging to a basic short-stroke-piston-in-cylinder type device 20. FIG. 4a shows the cylinder device 20 having a compressible gas chamber 18 in an expanded state and FIG. 4b shows the cylinder device 20 having a compressible gas chamber 18 in a compressed state.

The vessel 10 comprises a cylinder 22 and a piston 23 within the cylinder 22, the piston 23 including a piston head 24 for generally separating the gas chamber 18 from the liquid chamber 16. At least a portion of the piston 23 is slidable within the cylinder 22.

A compressible liquid-proof and gas-tight gaiter or bellows 26 is shown attached in a fluid tight manner to the internal end wall of cylinder 22 and piston head 24. In this embodiment, the gas chamber 18 is generally defined by the internal volume being contained between the internal end wall of cylinder 22, piston head 24 and the bellows 26. The internal portions of the bellows 26 are additionally provided with an array of two different types of opposed frusto-conical Belleville type spring devices 28, 30.

Flange 32 of spring 28 has an interfacing and co-operatively retaining relationship with lip 34 of spring 30 when springs 28, 30 are opposed as shown in FIGS. 4a and 4b. Flange 32 of spring 28 also has an interfacing and co-operatively retaining relationship with flange 36 on the internal end wall of cylinder 22. Lip 34 of spring 30 also has an interfacing and co-operatively retaining relationship with the flange 38 provided on piston head 24.

Frusto-conical Belleville type spring devices 28, 30 may optionally be provided as piezo-electric generator devices. Additional spring-like piezo-electric generators may be provided within the gas chamber 18. Electric cable outlets attached to the spring-like piezo-electric generators may exit the wall 22 preferably through closed end 40 for electrical transmission away from the rotatable loop element 12.

The internal portions of bellows 26 are provided with a closed end 40 and internal piston head 24 at the two axial ends such that the array of opposed frusto-conical Belleville type spring devices 28, 30 provide a close fit with bellows 26. The piston/cylinder system is shown axisymmetric about axis 42. The springs 28, 30 compress about fold lines 44. Other compressible spring devices may also be provided within the gas void 18.

Turning now to FIGS. 5 and 6, a rotatable loop element 12, comprised in this case of an array of sixteen non-latched piston type vessels 10, is indicated. Although sixteen vessels 10 are suggested, other numbers may be utilised.

The rotatable loop element 12 rotates in a clockwise direction. The top-most vessel 10a is shown with its gas chamber 18 fully expanded. The bottom-most vessel 10b is shown with its gas chamber 18 fully compressed.

Turning now to FIG. 7, this shows a cross-sectional view through a further embodiment of a vessel and shows adjacent latchable ‘piston/cylinder’ vessels 10. Each vessel 10 is attached to a neighbouring vessel 10 by a fulcrum 46 to construct a rotatable loop element. Each vessel 10 is provided with a latching device, indicated generally at 48.

In the right hand vessel 10 shown in FIG. 7, the piston 23 has been locked in its fully compressed state by the latching device 48. The latching device 48 indicated is to show just one of several practical means that may be used to latch-lock a piston 23 in its compressed state at or near the deepest place that a vessel 10 may reach in a deep liquid.

In the drawing, each of the two vessels 10 is provided with a latching device 48 having a ‘knee’ type joint at a fulcrum 52 that connects piston-lever 54 to vessel-lever 56. Piston-lever 54 is also connected to piston head 24 at fulcrum 58 and vessel-lever 56 is connected to vessel 10 at fulcrum 60. A connector arm 62 connects fulcrum 52 to valve-lever 64 at fulcrum 66. Valve lever 64 is provided with a fulcrum valve 68 having a valve power exit portal 70 provided therein.

It should be apparent from the right hand vessel 10 in FIG. 7 that the latching device 48 has locked the piston 23 such that valve power exit portal 70 prevents the liquid retained at or near the bottom-most part of the liquid chamber 16 from escaping through jetting aperture 72.

With reference now to the left hand vessel 10 in FIG. 7, the latching device 48 has been unlocked by clockwise rotation of fulcrum valve 68 by automated means (not shown) at or near the deep liquid's surface. Such rotation has forced the connector arm 62 to bend the straight ‘knee’ type joint at fulcrum 52, thereby releasing piston head 24. Such rotation has also rotated the valve power exit portal 70 to a position where the liquid stored under pressure in the liquid chamber 16 is allowed to escape under pressure through the jetting aperture 72.

FIG. 8 is a side view of part of a power generator whose top most parts emerge a certain distance from the surface 74 of the deep liquid 73, housed within a pair of deep liquid towers 75 as also schematically shown as a ‘U’ shape in FIG. 30. The power generator further includes an array of similar latchable ‘piston/cylinder’ vessels 10 aligned in, but not limited to, end-to-end configuration. The vessels 10 may be as described above, but are preferably all of the same configuration. A suitably adapted water-type turbine 77 is centred on the same horizontal rotational axis as the power generator's winch wheel 76. The direction of rotation of the water-type turbine 77 is indicated by arrow 78 and is shown to be clockwise.

The direction of rotation of the rotatable loop element 12 is indicated at 80 and is shown to be anti-clockwise. Up-moving charged vessels 10 are indicated at 82 and down-moving depleted vessels are indicated at 84. For vessels 10 having similar external dimensions of a deep diving whale, the rotatable loop element 12 may rotate at a sympathetic velocity of approximately 4 km/hr, whereas for a similar loop element 12, where vessels on the loop breach at the surface, a sympathetic velocity of 28 km/hr may be also be appropriate.

At a precise point 86 on an up-going part of the loop, the valve 68 (shown in FIG. 7) of each piston is de-latched. Each pressurised vessel 10 has its pressurised liquid automatedly released, indicated at 88, where it is immediately jetted onto the blades of the water-type turbine 77. The liquid pressure, the size and form of the jet, the design of the turbine blades and the size of the water-type turbine 77 wheel all contribute to the efficiency of the invention. Half de-compression of each vessel 10 occurs at position 90 and full decompression occurs shortly afterwards at position 92. Inclined channels 94 are provided for allowing liquid to return from the turbine to the deep liquid towers 75. Liquid enters the atmospheric side of each vessel 10, indicated at position 96, as soon as each vessel 10 re-enters the liquid in the deep liquid towers 75.

FIGS. 9, 10 and 11 indicate the operation of various de-latching mechanisms which operate as the latched vessel 10 advances towards and past a de-latching station, located for example at position 86 in FIG. 8.

In FIG. 9, the direction of travel of the rotatable loop element 12 is from left-to-right across the page as viewed. De-latching occurs at position 98 and the full length of the piston stroke after de-latching is indicated at 100.

FIG. 10 shows a diagrammatic view of a novel piston engine and is to be interpreted within the context of FIG. 9. A crank 102 is shown directly affixed to a rotatable drive shaft 103 for sequentially receiving latched vessels 10, marked as A-E in the drawing. The vessels A-E are shown travelling in a left-to-right direction across the page. All vessels 10 have a piston-to-crank connecting rod 105 rigidly attached to the piston. All vessels 10 have a roller bearing 107 attached to the ‘big-end’ of the connecting rod 105. The vessels 10 marked E, D, and C are still latched and have their gas chambers 18 fully compressed. The vessels 10 marked B and A are unlatched and have had their gas chambers 18 fully re-expanded. The drawing specifically shows the roller bearing 107 of vessel C coming into precise engagement with the crank 102 as the crank 102 (rotating clockwise) reaches top-dead-centre, whereupon the fulcrum valve 68, shown in FIG. 7, is de-latched. The vessel 10 (marked ‘B’) is shown in its fully depleted state, after moving from a position above the crank's 102 top-dead-centre to position B and in so doing has rotated the crank 102 clockwise through 90 degrees, ready for the crank 102 to then receive vessel C (as in the drawing) to repeat the process. Thus, FIG. 10 shows a piston engine, where the pistons momentarily engage with the crank 102 only for the time period to allow the piston's power stroke to rotate the crank 102. The energy harvesting means of the invention makes use of the liquid sequentially ejected from each liquid chamber 16 before being returned to the liquid reservoir. It should be apparent with reference to FIG. 8 that optionally a turbine connected to the shaft 103 of FIG. 10 may make use of the water ejected from vessels 10 A-E for furthering rotation of shaft 103.

A rack 91 (shown affixed but not restricted to the lowest part of each vessel 10) may engage with a pinion 93 on the cam's drive shaft 103, to assist in preventing rocking or tilting of each vessel 10 as the down-stroke takes place, whilst also assisting with rotation of the drive shaft 103 by making use of the momentum of rotatable loop element 12 between sequential piston down-strokes. The piston engine may be located in the top region of FIG. 30 between the two winch-wheels where the vessels 10 are travelling in a straight line during engagement with crank 102. It should be apparent, without the need for further drawings, that vessels 10 marked A to E in FIG. 10 may also traverse an arc line, and not just a straight line, traversing in tandem with annular support structure 11, as schematically defined in, for example, FIG. 3a and FIG. 3b whilst also engaging with crank 102.

FIG. 11 provides a diagrammatic plan view of a rotating de-latching mechanism for sequentially de-latching latched piston/cylinder type vessels 10 near the top of the rotational cycle.

Six rows (A to F) of vessels 10 are shown in FIG. 11 that have reached or almost reached the topmost part of the cyclical looping process.

In Row A, a chain of interconnected vessels 10 is shown in a first position. Each vessel 10 has the fulcrum valve 68, shown in FIG. 7, at or near the centre of the vessel 10 for allowing liquid into and out of the liquid chamber 16.

In Row B it will be seen that the rotatable loop element 12 has rotated such that the vessel 10 has moved forward by approximately one quarter the length of a vessel 10.

In Rows C, D, E and F it will again be seen that for each successive row, the rotatable loop element 12 has moved forward by approximately one quarter the length of a vessel 10, such that for Row E, vessel C is now in the exact same position that vessel B is in Row A.

Also shown for each row (A to F) is a valve opener support, indicated schematically as circle 106. The non-rotating main body (not shown) of the valve opener support 106 is rigidly affixed to the same chassis that holds the drive wheel (not shown) for moving the rotatable loop element 12. Affixed at or near the circumference of valve opener support 106 is a valve opener, indicated schematically as a hollow square 108.

In Row A, valve opener 108 is shown at the most Westerly part of the rotator 106. In Row B, valve opener 108 is shown at the most Northerly part of the rotator 106. In Row C, valve opener 108 is shown at the most Easterly part of the rotator 106. In Row D, valve opener 108 is shown at the most Southerly part of the rotator 106. In Row E, valve opener 108 is again shown at the most Westerly part of the rotator 106, as previously shown at Row A. As the valve opener support 106 rotates, it passes over the fulcrum valve 68 and opens it, as shown in rows B, D and F.

It should be apparent from the above description that the same de-latch and re-latch apparatus defined herein also applies for a single row of vessels as it does for six rows of vessels.

With reference now to FIG. 12, this drawing shows one half of a rotating turbine impellor 110 surrounded by one half of a static casing 112 that is provided with a plurality of portals 114, each being integrated with a directional liquid chute 116. The outer wall 118 of the casing 112 may be, though not necessarily, a part of the outer wall of a vessel 10 of the invention and in direct contact with the deep liquid.

Each chute 116 extends generally in a circumferential direction, and spirals from the exterior of the casing 112 to or adjacent to the tips or distal ends of the impellor 110.

Each chute 116 also preferably tapers from partway along its longitudinal extent and in this case from midway, to or adjacent to its ends.

In the drawing, the vessel 10 containing the impellor 110 and casing 112 represents a vessel 10 descending in a deep liquid. The direction arrows A, B and C show the direction of flow of the deep liquid flowing from the deep liquid through portals 114 for then being directed along directional chutes 116 for improved flow over the turbine blades 120 to rotate the shaft 122 of impellor 110 in the direction of arrow R. The direction arrows D, E and F show the direction of flow of the liquid after leaving the rotating impellor blades 120 and flowing through a plurality of impellor portals 124. The direction arrows H and J show the direction of flow of the liquid flowing towards the gas chamber 18 (not shown) after leaving impellor 110.

FIG. 13 is an isometric cutaway view showing a complete turbine impellor 110 with directional casing chutes 116 (best seen in FIG. 12) installed within the main body in a ‘piston/cylinder’ vessel 10. The vessel 10 may be aligned with similar such vessels 10 in side-by-side, end-to-end or end-to-centre configuration with respect to forming a power generator in accordance with the invention. It should be apparent, especially with reference to FIG. 12 and with particular regard to the slightly compressed spring 126 and the direction of liquid flow, as shown by arrows A, B, C and D, that the vessel 10 is somewhere near the top of the rotational cycle and descending through a deep liquid. From this disclosure, it should be apparent that as the vessel 10 descends, the greater the pressure from the deep liquid will become. This allows more liquid to enter portals 114, forcing more liquid into chamber 16 and then against piston head 24, so compressing the spring 126 even more. The spring 126 is set within the gas chamber 18, between the inner wall of cylinder 22 and piston head 24.

It should also be apparent, again with reference to FIG. 12, that shaft 122 of impellor 110 will be obliged to rotate due to liquid flow through the turbine blades 120. Devices including an electric generator (not shown) with or without a flywheel (not shown) may be affixed to shaft 122 after being installed within housing 128. Electric cable outlets (not shown) may also be provided in housing 128 for continuous delivery of electricity away from a vessel 10 of the invention. The spring 126 may be a spring-like piezo-electric generator and liquid-tight electric cable outlets (not shown) may also be provided (for example, through the internal end wall of cylinder 22) for additional continuous delivery of electricity away from a vessel 10 of the invention.

FIG. 14 is also an isometric view showing one half of the rotating turbine impellor 110 surrounded by one half of the static casing 112 that is provided with the plurality of portals 114, each being integrated with the directional liquid chute 116. In this drawing, the vessel 10 containing the impellor 110 and the casing 112 is ascending in a deep liquid, the opposite direction to that shown in FIG. 13. The direction arrows P and Q show the direction of flow of the liquid flowing away from the expanding gas chamber 18 and about to enter impellor 110. The direction arrows S, T and U show the direction of flow of the liquid after entering the plurality of impellor portals 124 and flowing through impellor blades 120 to maintain the rotation of impellor 110 in the direction of arrow R. The direction arrows V, W and X show the direction of flow of the liquid after leaving the rotating blades 120 of impellor 110 and flowing along the directional chutes 116 towards the portals 114 for return to the deep liquid. When referring to both FIG. 12 and FIG. 14, it should be apparent that impellor 110 has maintained the same rotational direction R for liquid flow in both directions. A flywheel (not shown) attached to shaft 122 may maintain rotational momentum of impellor 110 while the liquid pressure remains temporarily constant as a vessel 10 on the rotatable loop element 12 is at the bottom and/or top of a rotational cycle. It should also be apparent that various devices, including electricity generators may also be connected to shaft 122 of impellor 110.

With reference to FIG. 15, it should be apparent, especially with reference to FIG. 13, that the spring 126 has been compressed and the direction of liquid flow, as shown by arrows P, Q, R, S, T, and U, shows that the vessel 10 is somewhere near the bottom of the rotational cycle and is ascending through a deep liquid.

From this drawing, it should be apparent that as the vessel 10 ascends, the pressure from the deep liquid will decrease, allowing the spring 126 to expand again and force against piston head 24, thereby ejecting liquid from chamber 16 and forcing it back through impellor 110 for ejection from the vessel 10, via portals 114, to return to the surrounding deep liquid.

The spring 126 is shown within the gas chamber 18 of vessel 10, the gas chamber 18 being maintained by gas-tight and liquid-tight bellows 26 (not shown) between piston head 24 and the inner end wall of cylinder 22.

An optional flywheel (not shown) attached to the shaft 122 may maintain rotation of impellor 110 while a vessel 10 of the invention is at the top or bottom of the rotational cycle and liquid flow within the vessel 10 is in stasis before changing direction.

FIG. 16 shows a cross-sectional isometric view through the elongate cylindrical axis of a piston-type vessel 10 near the top of the rotational cycle. The gas chamber 18 is shown almost fully expanded. FIG. 17 shows a cross-sectional isometric view through the elongate axis of the piston-type vessel 10 near the bottom of the rotational cycle. The gas-chamber 18 is shown almost fully compressed. In FIGS. 16 and 17, the springs 126 and/or bellows 26 have been omitted for clarity. In these two drawings, the location of the portals 114 is more clearly apparent as being provided through the outer casing of the vessel.

As can be seen from FIGS. 16 and 17, the impellor 110 is mounted for rotation on the shaft 122 in impellor housing 110a which is formed in part by the casing 112. A base 110b of the impellor housing 110a within the casing 112 is preferably conical or frusto-conical and thus partitions the impellor housing 110a from the rest of the interior of the casing 112.

A series of apertures 110c for liquid flow from the impellor housing 110a to the liquid chamber 16 are provided, preferably equi-angularly spaced-apart at or adjacent to a perimeter edge of the base 110b. The perimeter edge may therefore define a planar arcuate portion in which the apertures 110c are provided, or may be formed contiguously with the sloping portion of the base 110b.

The shaft 122 may be hollow as shown in FIGS. 16 and 17, or closed dependent on necessity.

It may be beneficial to allow jetting liquid expulsion via the hollow shaft 122 during movement of the vessel 10 and expansion of the gas chamber 18. In this case, it is preferable to include a one-way valve or check valve (not shown) to prevent or limit liquid ingress to the liquid chamber 16 via the hollow shaft 122. Furthermore, to in this case prevent or limit liquid egress via the apertures 110c rather than the hollow shaft 122, a second one-way or check valve, which is not shown but which may for example be a neoprene gator or other diaphragm, may close the apertures 110c.

A further embodiment of the rotatable loop element 12 is now described, in which the gas chamber is provided by a compressible and expandable lung system and not by a collapsible and expandable piston/cylinder system, as described in the previous embodiment and arrangements. The piston/cylinder system of the earlier embodiment and the compressible lung system of this further embodiment have different structural means for achieving the same functional outcome: to generate power by simple rotation of the rotatable loop element 12. FIG. 18 is a schematic perspective view showing sixteen positional cross sections laterally through a further arrangement of the rotatable loop element 12 of a second embodiment of power generating apparatus 10. The rotatable loop element 12 in this case includes a first example of a collapsible and expandable lung system which replaces the piston and cylinder arrangements hereinbefore described. FIG. 19 shows, face on, the lateral cross sectional views of the rotatable loop element 12 at the sixteen circumferential positions shown in FIG. 18. The nine positions shown by FIGS. 19a to 19i correspond to the sixteen circumferential positions and therefore the nine pressure/depth positions shown in FIG. 18 when the loop element is immersed in a deep liquid.

With reference to FIGS. 18 and 19, in this embodiment, the rotatable loop element 12 forming at least part of the lung system comprises a toroidal housing 200 and a toroidal expansion/contraction member indicated generally at 202 in FIG. 19 and FIG. 20. The expansion/contraction member 202 forms a flexating, expandable and compressible liquid-tight and gas-tight diaphragm that forms at least a part of the moveable separating means which encloses, and in this embodiment defines, the gas chamber 18. The liquid chamber 16, which is situated between the housing 200 and the expansion/contraction member 202, permanently stores liquid within, which then rotates as the in use rotatable loop element 12 rotates.

As better seen in FIG. 20, the expansion/contraction diaphragm 202 comprises a plurality of interconnected links for facilitating expansion and contraction of the gas chamber 18. In this embodiment, eight rigid and non-collapsible link elements 204 having a preferably triangular lateral cross section are interspaced by eight sets of jointed link elements 206. The advantage of the rigid link elements 204 being generally triangular in lateral cross-section is that the rigid link elements 204 help guide the jointed link elements 206 into a compact formation as the expansion/contraction diaphragm 202 contracts. For clarity, the link elements 204, 206 extend in the lateral circumferential direction of the rotatable loop element 12.

One of the link elements, indicated at 204A, is fixedly attached to the housing 200. Link element 204A has been modified to include a power exit portal 208, which provides gas tight and liquid tight access for electrical cabling between the liquid chamber 16, the gas chamber 18 and all link elements 204, 204A, 206.

By considering FIG. 18 with Figures la to 3b in mind, it should be apparent that this further embodiment of the rotatable loop element 12 may be circular or elliptical.

As indicated in FIGS. 21 and 22, at least two of piezo electric devices 210 may be disposed within one or more of the links elements 204, 204A, 206 (as shown in FIG. 20). As such, the link elements 204, 204A, 206 may be at least partially hollow. As the assembled expansion/contraction member 202 expands from the position shown in FIG. 21 to the position shown in FIG. 22, the piezo-electric generator devices 210 flex and unflex (or stress and de-stress) as appropriate, and this movement generates electricity in the devices. Likewise, as the assembled expansion/contraction member or diaphragm 202 contracts, for example, from the position shown in FIG. 22 to the position shown in FIG. 21, again the piezo-electric generator devices 210 flex and unflex (or stress and de-stress) as appropriate, and this flexing movement again generates electricity outputable by in the piezo-electric generator devices.

FIG. 23 shows an enlarged cross-sectional view of the rotatable loop element 12, being a modified version of the further embodiment of the invention, generally at position “b” shown in FIG. 19. FIG. 24 shows an enlarged cross-sectional view of the modified rotatable loop element 12 generally at position “h” shown in FIG. 19.

In this modified version, the rotatable loop element 12 is provided with a spring-like piezo-electric generator 212 which, in FIG. 23, is in the process of expanding and functionally corresponds to the expanding spring 126, shown in FIG. 15. The top most rigid link element 204 has been modified to become 204B and incorporates a planar pressure plate 214 which functionally corresponds to that of piston head 24 of FIG. 15. The top most part of spring-like piezo-electric generator 212 is shown connected to planar pressure plate 214. Similarly, rigid link element 204A of FIG. 20 has been modified to become modified rigid link element 204C, by having a planar pressure plate 216 for captively retaining the bottom most part of spring-like piezo-electric generator 212. From the drawing, it will be apparent that the rigid link elements 204, 204B and 204C, and jointed link elements 206 together form the lung walls of the diaphragm 202 for retaining a captured gas volume.

In FIG. 23, the spring-like piezo-electric generator 212 has or has almost achieved full compression, corresponding to a position at or around the bottom of a rotational cycle of the rotatable loop element 12. In FIG. 24, the spring-like piezo-electric generator 212 is at or near full expansion. This corresponds to a position at or near the top of the rotational cycle.

FIGS. 25 and 26 show an enlarged view of part of another expansion/contraction member or diaphragm 202 of a second example of a collapsible and expandable lung system. In this case, the rotatable loop element 12 forming part of the lung system as before is at or near the top of a rotational cycle in FIG. 25, and at or near the bottom of the rotational cycle in FIG. 26.

The drawing shows further structural details of the expansion/contraction diaphragm 202 in a circumferential direction of the rotatable loop element 12. The expansion/contraction diaphragm 202 having the gas chamber 18 is compartmentalised into a series of arcuate interconnected gas compartments 218.

Each compartment 218 is separated from a neighbouring compartment 218 by a pressure differential gaiter 220. The pressure differential gaiters 220 are preferably both flexible and resilient.

An extended spring-like piezo-electric generator 222, similar to that of spring-like piezo-electric generator 212 traverses each compartment 218 such that it is confined between support member 224 (similar in function to pressure plate 214) and support member 226 (similar in function to pressure plate 216 in FIG. 24).

One or more further spring-like piezo-electric generators 228 may be incorporated within pressure differential gaiters 220. The piezo-electric generators 221, 222, 228 are shown schematically as being electrically connected inside the liquid-tight arcuate compartments 218 by schematic cabling 230, 232 that also passes through power exit portal 208 to provide electrical transmission away from the invention.

By referring to the arrowed line E near the top of FIG. 25, this length E denotes the length of the support member 226 at or near the top of the rotational cycle.

For best referral of FIG. 26 with FIG. 25, FIG. 26 is shown upside down. By referring to the arrowed line E near the top of FIG. 26, and the arrowed line C positioned below it, it should be apparent that the support member 226 has compressed by a length E minus C. It should also be apparent from this information that the piezo-electric generator 221 contained within support member 226 will have also been obliged to compress, thereby generating electricity.

Similarly, spring 222 has also compressed when comparing FIGS. 25 and 26, again generating electricity. Referring now to the pressure differential gaiters 220 in FIG. 26, it will be seen that they have flexed into the chamber 18 obliging the spring-like piezo-electric generators 228 to have stressed relative to their positions shown in FIG. 25, thereby again generating electricity. In other words, as the rotatable loop element 12 rotates within a body of liquid and the compartments 218 expand (FIG. 25) and contract (FIG. 26) according to their position on the rotational cycle, the spring-like piezo-electric generators 221, 222, 228 flex and unflex (or stress and de-stress) as appropriate, and this movement generates electricity in the devices.

FIGS. 25 and 26 show the expansion/contraction diaphragm 202 enclosed within a single walled toroidal housing 200, as shown in FIG. 27, though it may equally be enclosed within a further concentric toms, as will now be described with reference to FIG. 27a.

The toroidal housing 200 is provided with a concentric inner toms 236 to provide a separation wall within the enclosed liquid chamber 16 to provide a main body of liquid chamber 237 that sits between toms 236 and torus 200 and a secondary liquid chamber 238 that sits between torus 236 and the sub-divided gas chamber 18 enclosing respective gas volumes, as described with reference to FIGS. 25 and 26. Provided in the wall of the inner toms 236 are portals 240 for limiting ingress and egress between the two bodies of liquid.

Optional valve devices (not shown) may limit or enable liquid in chambers 237, 238 to move therebetween more efficiently.

Sixteen individual gas compartments 218 are shown circumnavigating the inner wall of the torus 236. Although sixteen gas compartments 218 are provided, other numbers are possible.

Optional valve devices (not shown) may limit or enable liquid to ingress and egress between the two bodies of liquid held in chambers 237, 238 more efficiently, The piezo-electric devices defined for FIGS. 23 & 24 are equally applicable for use in FIG. 25, but are not shown in FIG. 25 for clarity. However, in some practical applications of the invention, the pressure differential gaiters 220 may not necessarily be essential to the invention, in which case the compartmentalised gas chamber 18 is dispensed with in favour of a single continuous gas chamber, as shown indicated in FIG. 28.

FIG. 28a represents perhaps the simplest form of the invention in that very few internal moving parts may be involved. For example, if the expansion/contraction diaphragm 202 as detailed in FIGS. 25 to 28a is manufactured as a single unit, such as by plastics extrusion, the extrusion may then be cut to required length and assembled with or without end seals 244 in a manner to provide a single gas tight and liquid tight gas chamber 18 that extends around the interior of the housing 200. In such an arrangement, electricity may still be generated using spring-like piezo-electric generators as previously defined after incorporation within the hollow parts of such an extruded form before the extrusion is assembled.

The partitioned or unpartitioned expansion/contraction diaphragm or lung member 202 is preferably held to the housing 200 at at least one point so as to be angularly fixed relative to the rotatable housing 200. The point of fixation is beneficial in enabling harvested energy output, for example, as shown in FIGS. 25 and 26. However, it may be feasible that the expansion/contraction diaphragm or lung member 202 is/are able to circumnavigate or rotate within the interior of the housing 200. In this case, wireless energy transfer may be considered, for example, via inductance or resonant inductance.

As with FIG. 27, power exit portals 234 may also be incorporated within FIG. 28 to provide the same cable exit function. For a simple device, only one power exit portal 234 may be necessary to allow the cabling to exit.

It should be apparent by referring to FIG. 28a that multiple power exit portals 234 may be omitted and only a single power exit portal may be provided, and additionally or alternatively an inner torus 236 (see FIG. 28) need not be provided.

The lung system as described with reference to FIGS. 18 to 28a, inclusive, utilises a diaphragm 202 of generally circular form. It should be apparent without the need for further drawings that other cross sectional forms for diaphragm 202 may be applicable, such as pillow shaped, star shaped, or any other practical gas enclosing cross sectional form.

Additionally or alternatively, a diaphragm 202 may be provided having a general line or sheet form to partition the interior of torus 200 in a circumferential direction. Each longitudinal, preferably parallel or substantially parallel, edge of the diaphragm may be affixed at spaced apart positions at two places on an inner wall of torus 200 to provide a separate gas chamber 18 and liquid chamber 16. The two places may be diametrically opposite each other. As the pressure changes during rotation, the diaphragm flexes enabling energy harvesting as described above.

FIGS. 29, 30, 31 and 32 each indicate various practical situations in which the power generator in the various embodiments described above may be incorporated.

In FIG. 29, a converted floating vessel 146, that may be a converted lifeboat, container ship or oil platform, is indicated making use of the power generator, with the rotatable loop element 12 of vessels 10 extending down below the surface of the water by depth D, shown in the drawing as representing, but not restricted to a depth of around 50 metres (or 25 fathoms). In FIG. 29, the loop is shown as elongate but may also equally be arranged as a circular loop.

In FIG. 30, two deep liquid tubes 148 are connected to a bottom tube 150 to create a ‘U’ shaped deep liquid device for containing a deep liquid 172 for use against, for example, a scaffolding support structure, set against a building, a quarry wall or other suitable support. The addition of upper tubes would provide means to obtain a practical depth in an ‘on-land’ situation.

In FIG. 31, the rotatable loop element 12 is shown in use within a bore hole 152. An engine or turbine, the location of which is indicated generally at 154, drives a loop wheel 156 to rotate the rotatable loop element 12 comprised of vessels 10. Any excess water runoff, such as unwanted rainwater from the loop wheel 156 may be directed away from the immediate operational area by pipe 158. Solar panels 160 and/or a wind turbine 162 may be used to generate the electricity for powering a priming motor and/or drive motor.

In FIG. 32, a pair of optionally contra-rotating rotatable loop elements is incorporated into special water towers provided within a tall building 162 or other free-standing structure that may include a skyscraper type building. The rotatable loop elements are rotationally driven by electric loop harmonic drive motors 164, and may be electrically supported by solar panel arrays 166. Optional water turbine driven electricity generators are located at 168. A liquid return chute, required to collect liquid discharged from the water turbine electricity generators 168, for return to the liquid towers, is indicated at 170.

Additional or alternative drive means may also be considered. Air may be introduced at depth into one or more receiving chambers in or on each vessel 10. The air may be piped into the deep liquid 172 to be discharged in or adjacent to the vessels 10 at or adjacent to the bottom of the rotatable loop element 12. The discharging air is captured by the receiving chamber of each vessel 10, increasing the buoyancy of each vessel 10, and thus providing motive force. The air is then discharged from each receiving chamber as the respective vessel 10 reaches or passes the top of the rotatable loop element 12.

As mentioned previously, the drive means may be or include naturally occurring energy sources. For example, since a deep liquid is required, gas discharged from undersea fissures can be utilised. Piping of the discharged gas to the receiving chambers of the vessels 10 provides temporary buoyancy enabling a rotational drive to be imparted to the rotatable loop element 12.

FIG. 33 is a cross-sectional front view and FIG. 34 is a cross-sectional isometric view of end-to-end piston-type vessels 10 set within a fully enclosed body of deep liquid 172 as a further example of potential usage. A bespoke housing 200 encloses the body of deep liquid 172. In this arrangement, it is feasible though not preferable that the housing 200 may be rotatable relative to the rotatable loop element 12. It is alternatively feasible that the housing 200 may remain static with the vessels 10 rotating within, or that the housing 200 and the vessels 10 rotate together as a single unit.

For clarity purposes, no exit portals 208, 234 have been shown exiting the vessels 10 through the toms 200 in FIGS. 33 and 34

Optionally in all embodiments, a harmonic drive gearing system interconnects the drive means and the rotatable loop element 12.

Accordingly, there is provided a power generator that makes use of liquid pressure differentials that are known to exist at all depths of a fluid reservoir, by providing a power generating apparatus, for rotation in a deep liquid. Thus, derived energy generation from rotation of the rotatable loop element may be brought from the lowest part of the rotation cycle for use at the top of the cycle as mechanical or electrical power, or extracted at any location on the rotation cycle for transmission to the surface or in any case away from the invention. Such action occurs naturally due to the pressure differentials experienced by the rotatable loop element when it rotates in liquid. The embodiments described above are provided by way of example only, and various changes and modifications will be apparent to persons skilled in the art without departing from the scope of the present invention as defined by the appended claims.

1. A power generating apparatus comprising a deep liquid container having a deep liquid therein, an endless rotatable loop element at least in part in the deep liquid container and configured to be rotated by a driver about a horizontal or substantially horizontal axis of rotation, and energy harvester associated with the rotatable loop element, the rotatable loop element comprising at least one vessel including at least one variable-shape fluid-tight gas chamber and movable separator defining at least in part the gas chamber, the in use movable separator being at least partially movable in response to a change in hydropressure during rotation of the rotatable loop element and the in use energy harvester harvesting energy as the movable separator moves, wherein the deep liquid container includes an endless housing forming an enclosed liquid chamber for the said deep liquid, and the movable separator of the said at least one vessel of the rotatable loop element includes an endless movable separating member within the housing, the movable separating member enclosing the gas chamber in a radial direction.

2. The power generating apparatus as claimed in claim 1, wherein the deep liquid container is located in an open body of water.

3. The power generating apparatus as claimed in claim 2, wherein the open body of water is at least one of a reservoir, river, lagoon, sea, and ocean.

4. The power generating apparatus as claimed in claim 1, wherein the deep liquid within the deep liquid container is rotatable with the endless rotatable loop element.

5. The power generating apparatus as claimed in claim 1, wherein the liquid chamber includes a plurality of arcuate and spaced apart baffles disposed therewithin.

6. The power generating apparatus as claimed in claim 1, wherein the movable separator forms at least part of a collapsible/expandable lung member.

7. The power generating apparatus as claimed in claim 5, wherein the collapsible/expandable lung member is connected to the endless housing.

8. The power generating apparatus as claimed in claim 1, wherein the endless housing is toroidal, or substantially toroidal.

9. The power generating apparatus as claimed in claims 1, wherein the endless housing is one of at least substantially circular toroidal form or at least substantially elongate toroidal form.

10. (canceled)

11. The power generating apparatus as claimed in claim 1, wherein the endless housing is of endless elongate band form.

12. The power generating apparatus as claimed in claim 1, wherein the movable separation means is toroidal or substantially toroidal.

13. The power generating apparatus as claimed in claim 1, wherein the movable separation means is of endless elongate band form.

14. The power generating apparatus as claimed in claim 1, wherein the movable separator comprises a plurality of fluid-tight interconnected links to enable contraction of the gas chamber.

15. The power generating apparatus as claimed in claim 14, wherein at least one of the links is one-piece.

16. The power generating apparatus as claimed in claim 15, wherein the one-piece link has a triangular or substantially triangular lateral cross-section.

17. The power generating apparatus as claimed in claim 15, wherein at least one further said link interconnects the one-piece link by having two or more pivotably interconnected link portions.

18. The power generating apparatus as claimed in claim 15, wherein the energy harvester includes at least one piezo-electric device disposed within one or more of the said links.

19. The power generating apparatus as claimed in claim 1, wherein the rotatable loop element is circumferentially subdivided into a plurality of compartments to form a plurality of said vessels, each compartment being separated from an adjacent compartment by a flexible and resilient pressure differential gaiter.

20. The Power generating apparatus as claimed in claim 19, wherein the energy harvester includes at least one piezo-electric device disposed within one or more of the said pressure differential gaiters.

21. The power generating apparatus as claimed in claim 1, wherein the said at least one vessel is rotatable together with the deep liquid container.

22. The power generating apparatus as claimed in claim 1, wherein the energy harvester includes at least one piezo-electric device.

23. The power generating apparatus as claimed in claim 22, wherein the movable separator includes a spring element, the energy harvester including a piezo-electric device provided with the spring element configured to output electrical energy on movement of the movable separator.

24. The power generating apparatus as claimed in claim 1, wherein the deep liquid container is an enclosure fully housing the rotatable loop element, the deep liquid container and the rotatable loop element being held angularly stationary or substantially stationary relative to each other during rotation.

25. The power generating apparatus as claimed in claim 1, further comprising a harmonic drive gearing system interconnecting the driver means and the rotatable loop element.

26. The power generating apparatus as claimed in claim 1, further comprising a compressible gas in the gas chamber, such that the gas chamber has maximum volume as the vessel of the rotatable loop element reaches a top of a rotational cycle and has a minimum volume as the vessel reaches a bottom of the rotational cycle.

27. A method of generating power using power generating apparatus as claimed in claim 1, the method comprising the steps of rotating the rotatable loop element, the energy harvester using a movement of the movable separator during a rotational cycle to generate power.

28. The method as claimed in claim 27, wherein the deep liquid container is rotated together with the rotatable loop element.

29. A power generating apparatus for use in conjunction with a deep liquid, the apparatus comprising an endless and at least in part rotatable loop element configured to be rotated by a driver about a horizontal or substantially horizontal axis of rotation, and an energy harvester, the endless loop element comprising a stationary or rotatable liquid chamber, a fluid-tight compressible and expandable gas chamber rotatable with or relative to the liquid chamber, and a movable separator separating the liquid chamber from the gas chamber, the in use movable separator being at least partially movable in response to a change in hydropressure and the energy harvester harvesting energy as the movable separation means moves.

30. A method of manufacture of power generating apparatus as claimed in claim 1, wherein a density of a material used to form any one or more parts or whole of the deep liquid container, the endless rotatable loop element, drive means, and the energy harvester relative to the density of the chosen deep liquid in the deep liquid container is such that minimal drive input energy is necessary to rotate the endless rotatable loop element in or with the deep liquid.
